(19) United States
(12) Patent Application Publication
(10) Pub. No.: US 2006/0176708 A1
(43) Pub. Date: Aug. 10, 2006

(54) Single arm mogul mount for sports lighting fixtures

(75) Inventors: Myron K. Gordin, Oskaloosa, IA (US); Timothy J. Boyle, Oskaloosa, IA (US)

Correspondence Address: MCKEE, VOORHEES & SEASE, P.L.C., 801 GRAND AVENUE, SUITE 3200, DES MOINES, IA, 50309-2721, US

(73) Assignee: MUSCO CORPORATION, Oskaloosa, IA (US)

(21) Appl. No.: 11/333,996

(22) Filed: Jan. 18, 2006

Related U.S. Application Data
(60) Provisional application No. 60/644,687, filed on Jan. 18, 2005.
(60) Provisional application No. 60/644,639, filed on Jan. 18, 2005.
(60) Provisional application No. 60/644,536, filed on Jan. 18, 2005.
(60) Provisional application No. 60/644,747, filed on Jan. 18, 2005.
(60) Provisional application No. 60/644,534, filed on Jan. 18, 2005.
(60) Provisional application No. 60/644,720, filed on Jan. 18, 2005.
(60) Provisional application No. 60/644,688, filed on Jan. 18, 2005.
(60) Provisional application No. 60/644,636, filed on Jan. 18, 2005.
(60) Provisional application No. 60/644,517, filed on Jan. 18, 2005.
(60) Provisional application No. 60/644,609, filed on Jan. 18, 2005.
(60) Provisional application No. 60/644,516, filed on Jan. 18, 2005.
(60) Provisional application No. 60/644,546, filed on Jan. 18, 2005.
(60) Provisional application No. 60/644,547, filed on Jan. 18, 2005.
(60) Provisional application No. 60/644,638, filed on Jan. 18, 2005.
(60) Provisional application No. 60/644,537, filed on Jan. 18, 2005.
(60) Provisional application No. 60/644,637, filed on Jan. 18, 2005.
(60) Provisional application No. 60/644,719, filed on Jan. 18, 2005.
(60) Provisional application No. 60/644,784, filed on Jan. 18, 2005.

(51) Int. Cl. F21S 8/00

(52) U.S. Cl. 362/427

(57) ABSTRACT

An apparatus and method for a high intensity lighting fixture. One aspect, a knuckle for mounting the light fixture by its bulb cone to a cross arm is attached along the side of the bulb cone. This has various potential advantages including decreased effective projected area, protection of watering to the bulb cone, and decreased moment.

### CROSS REFERENCE TO RELATED APPLICATIONS

This application claims priority under 35 U.S.C. § 119 of a provisional application U.S. Ser. No. 60/644,719 filed Jan. 18, 2005, herein incorporated by reference in its entirety. This application is also a non-provisional of the following provisional U.S. applications, all filed Jan. 18, 2005: U.S. Ser. No. 60/644,639; U.S. Ser. No. 60/644,536; U.S. Ser. No. 60/644,747; U.S. Ser. No. 60/644,534; U.S. Ser. No. 60/644,720; U.S. Ser. No. 60/644,688; U.S. Ser. No. 60/644,636; U.S. Ser. No. 60/644,517; U.S. Ser. No. 60/644,609; U.S. Ser. No. 60/644,516; U.S. Ser. No. 60/644,546; U.S. Ser. No. 60/644,547; U.S. Ser. No. 60/644,638; U.S. Ser. No. 60/644,537; U.S. Ser. No. 60/644,637; U.S. Ser. No. 60/644,784; U.S. Ser. No. 60/644,687, each of which is herein incorporated by reference in its entirety.

### INCORPORATION BY REFERENCE

The contents of the following U.S. Patents are incorporated by reference by their entirety: U.S. Pat. Nos. 4,816,974; 4,947,303; 5,161,883; 5,600,537; 5,816,691; 5,856,721; 6,036,338.

### I. BACKGROUND OF THE INVENTION

A. Field of the Invention

The present invention relates to lighting fixtures that produce high intensity, controlled, and concentrated light beams for use at relatively distant targets. In particular, the invention relates to such lighting fixtures, their methods of use, and their use in systems where a plurality of such fixtures are used in combination, usually elevated on poles, to compositely illuminate a target area energy-efficiently, with reduced glare and spill light, and with the capability to lower capital and/or operating costs. One primary example is illumination of a sports field.

B. Problems in the Art

Illumination of sports fields is generally called sports lighting. FIGS. 1A-1G illustrate one such sports lighting configuration. Football field 5 of FIG. 1A is illuminated by a set of arrays 1 of light fixtures 2 elevated on poles 6 (see FIG. 1A). As is well known in the art, there are known methods to design the number, type, and position of poles 6 and fixtures 2 to provide a desired or required amount and uniformity of light for the field. There are usually pre-designed lighting quantity and uniformity specifications to follow.

The most conventional form of sports lighting fixture 2 is a several feet in diameter bowl-shaped aluminum reflector with a transparent glass lens 3 suspended from a cross arm 7 fixed to a pole 6 by an adjustable knuckle 4 (see FIG. 1B). Each light fixture 2 has some adjustability both around vertical and horizontal axes. Each fixture 2 can therefore be uniquely aimed relative to the target area or field 5 by adjustment of knuckle 4 relative cross arm 7.

This general configuration of sports lighting fixtures 2 has remained relatively constant over many years because it is a relatively economical and durable design. It represents a reasonable compromise between the desire to economically control high intensity light to a distant target while at the same time minimizing wind load, which is a particularly significant issue when fixtures are elevated out-of-doors to sometimes well over 100 feet in the air. A much larger reflector could control light better. However, the wind load would be impractical. A significant amount of the cost of sports lighting systems involves how the lights are elevated. The more wind load, the more robust and thus more expensive, the poles must be. Also, conventional aluminum bowl-shaped reflectors are formed by a spinning process.

Therefore, competing interests and issues provide challenges to sports lighting designers. Some of the interests and issues can be at odds with one another. Designers have to balance a number of factors, for example, cost, durability, size, weight, wind load, longevity, and maintenance issues, to name a few. Attempts to advance the art have mainly focused on discrete aspects of sports lighting.

### II. SUMMARY OF THE INVENTION

The present invention relates to a lighting fixture and structure to suspend it adjustably from a cross-arm. A relatively thin, single arm comprises the connection between cross-arm and mounting mogul or bulb cone, which in turn supports the remainder of the fixture. The single-arm provides several benefits for the fixture.

A. Objects, Features, or Advantages, of the Invention

It is therefore a principal object, feature, or advantage of the present invention to present a high intensity lighting fixture, its method of use, and its incorporation into a lighting system, which improves over or solves certain problems and deficiencies in the art.

Other objects, features, or advantages of the present invention include such a fixture, method, or system which can accomplish one or more of the following:

a) is robust and durable for most sports lighting or other typical applications for high intensity light fixtures of this type, whether outside or indoors;

b) can provide for decreased wind load or EPA for the fixture;

c) can provide for increased protection of wiring to the fixture;

d) can provide for decreased moment between the fixture and the mount.

These and other objects, features, advantages and aspects of the present invention will become more apparent with reference to the accompanying specification and claims.

### III. BRIEF DESCRIPTION OF THE DRAWINGS

All references to Figures are to the drawings in attached Appendix A.

A. General Sports Lighting Systems

FIG. 1A and its sub-parts B-G illustrate generally a sports lighting system, and conventional components for a sports lighting system.

B. General Parts of Fixture 10

FIG. 2 is a diagrammatic, partial exploded view of a light fixture 10 according to an exemplary embodiment of the present invention.

FIGS. 3A and B and FIGS. 4A and B show different assembled versions of Fixture 10.

C. Reflector Frame 30 (Diverging Bottom and/or Side Shift)

FIG. 5A and its sub-parts are plan views of one example of a reflector frame according to an exemplary embodiment of the present invention.

D. Lamp Cone 40

FIG. 6A and its sub-parts are various plan, sectional, and isolated views of a lamp cone according to an aspect of the invention.

E. Knuckle Plate 60

FIG. 7A and its sub-parts are a perspective view, various plan views, sections, and isolated views of a knuckle plate according to an aspect of the invention.

FIG. 8A and sub-parts illustrate a gasket used with Fixture 10.

FIG. 9A and its sub-parts are various views of a bolt for holding a knuckle of FIG. 14 to the lamp cone of FIG. 6.

FIG. 10A and its sub-parts are various views of an O-ring the seal the knuckle bolt of FIG. 9AA.

FIG. 11A and its sub-parts are various views of a washer useable with the knuckle bolt.

FIG. 12A and its sub-parts are various views of a washer useable with the knuckle O-ring of FIG. 10A.

FIG. 13A and its sub-parts are various views of a knuckle cone strap bolt useable with the knuckle of FIG. 14A and the lamp cone of FIG. 6A.

F. Knuckle 50

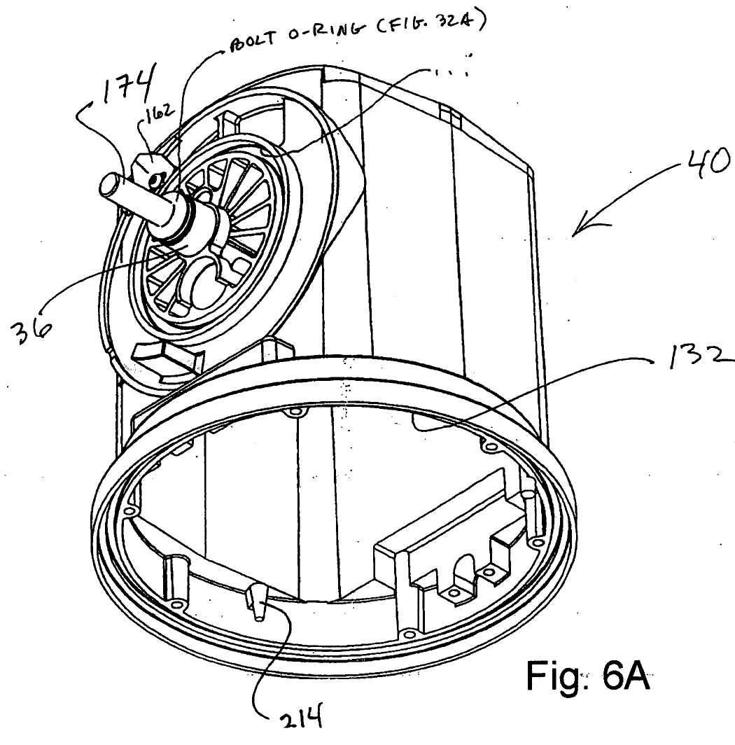

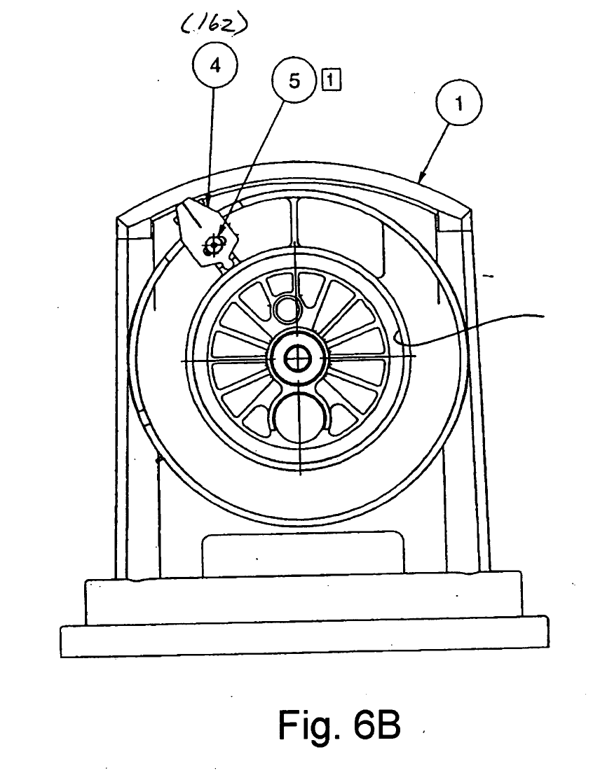

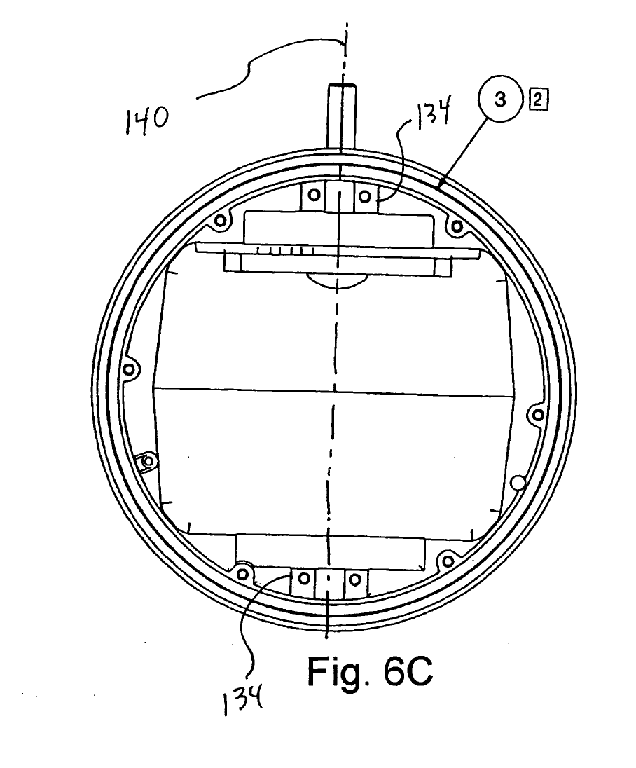

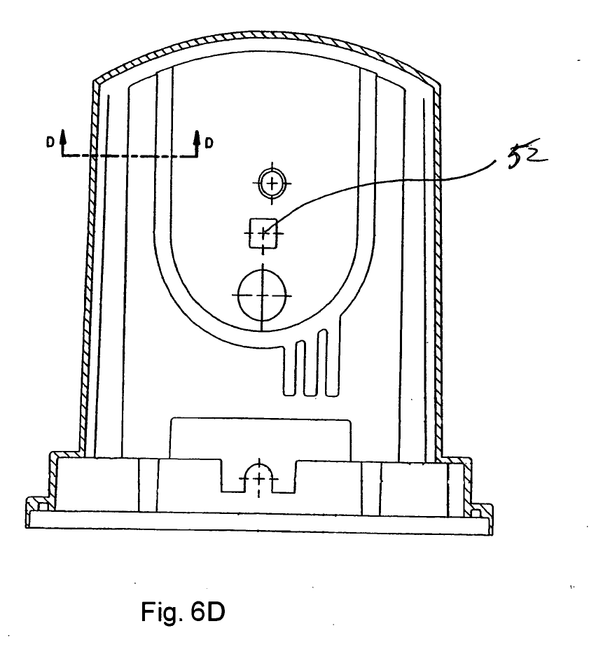

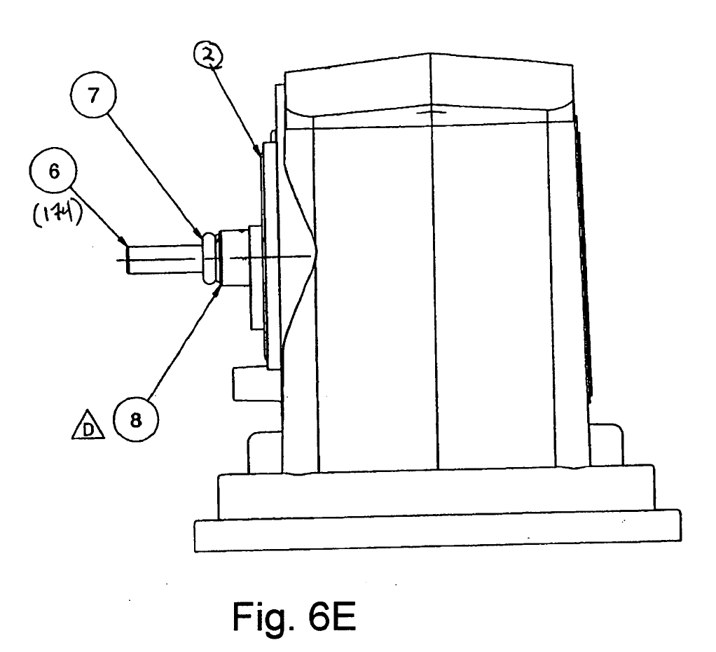

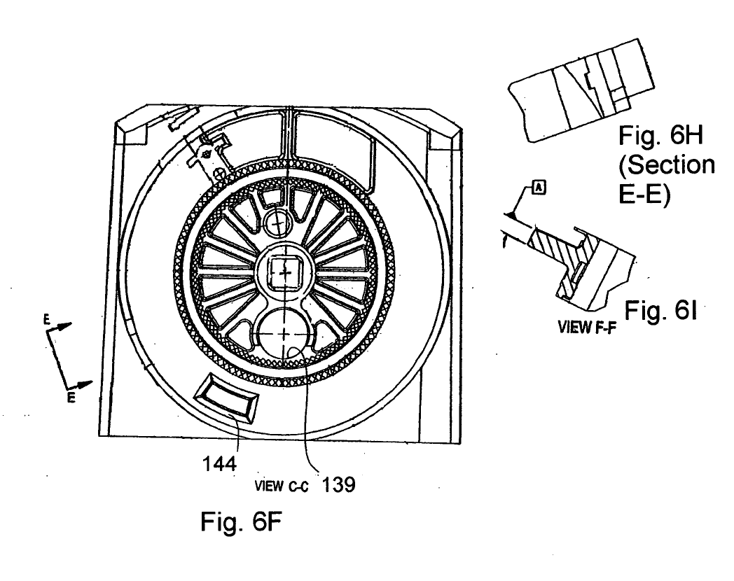

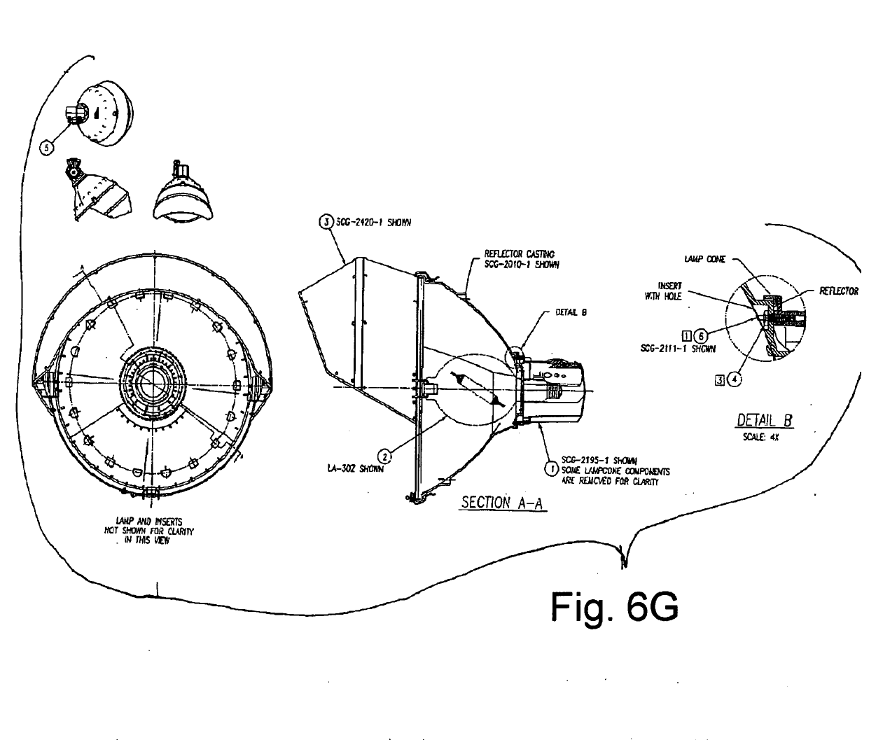

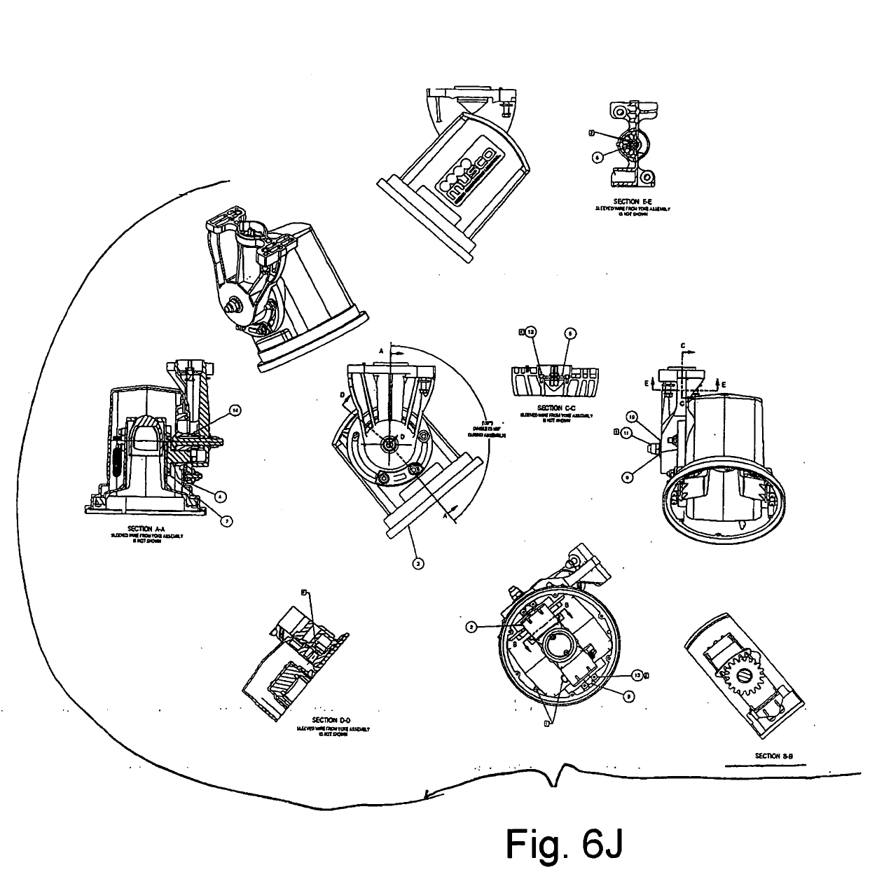

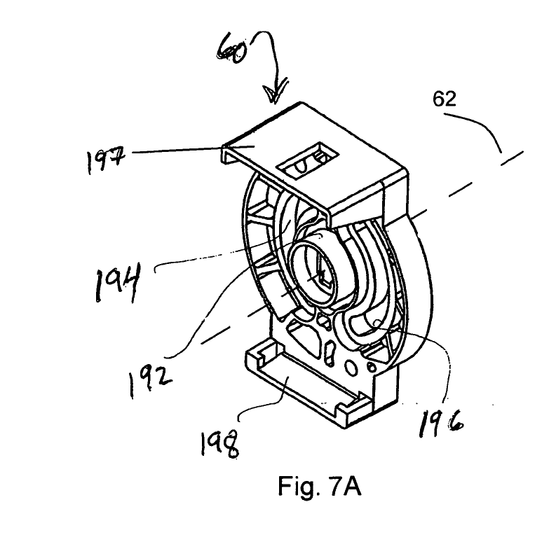

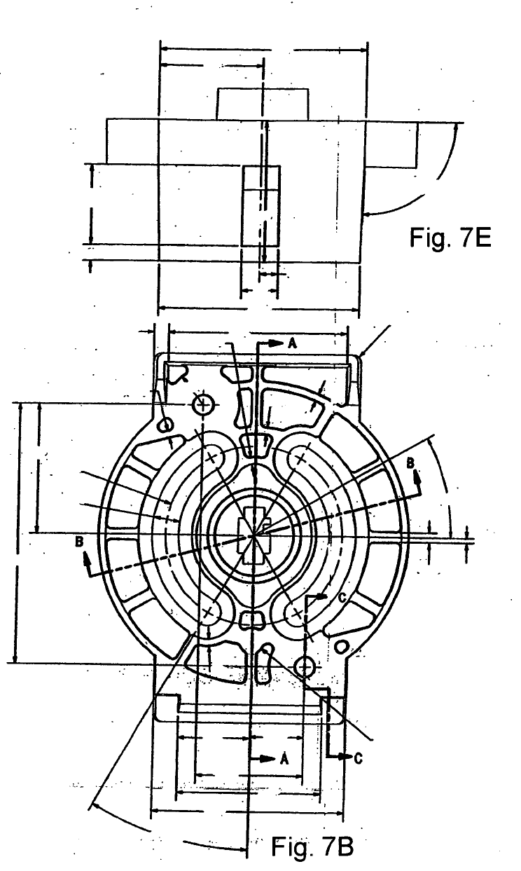

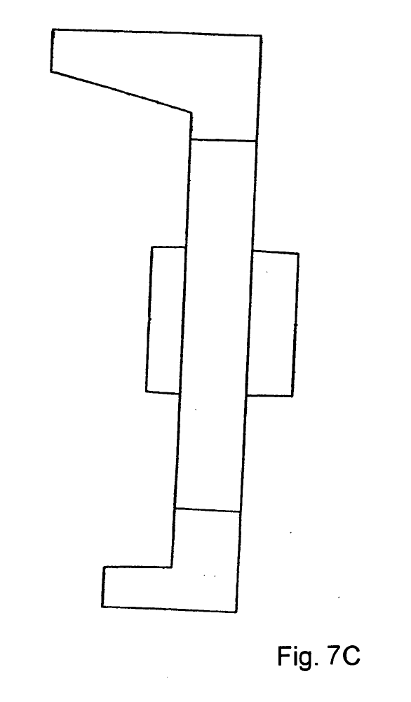

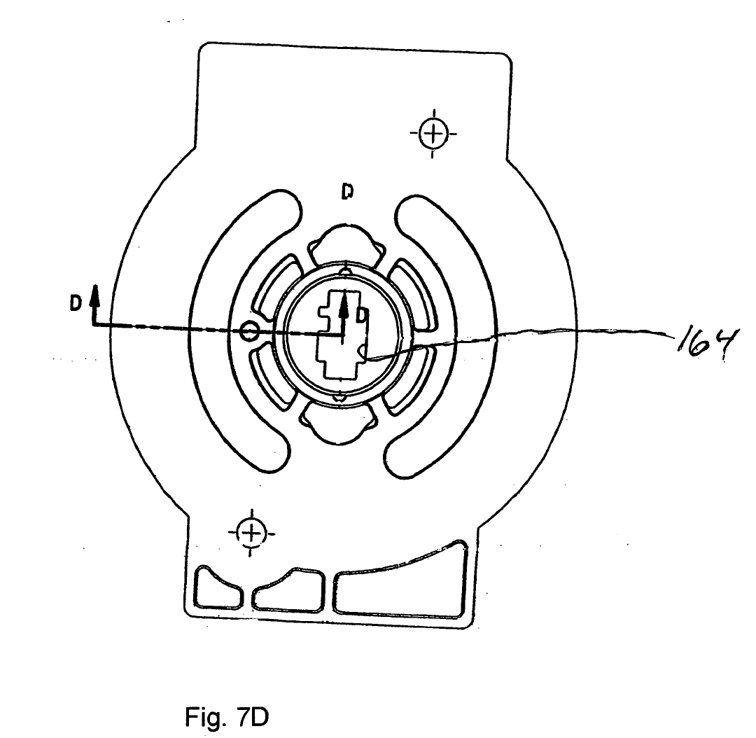

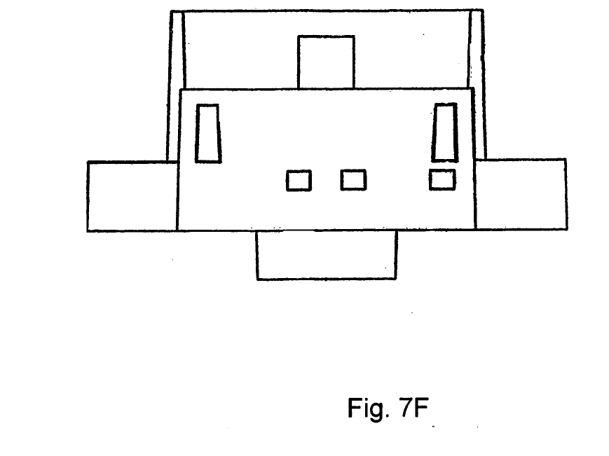

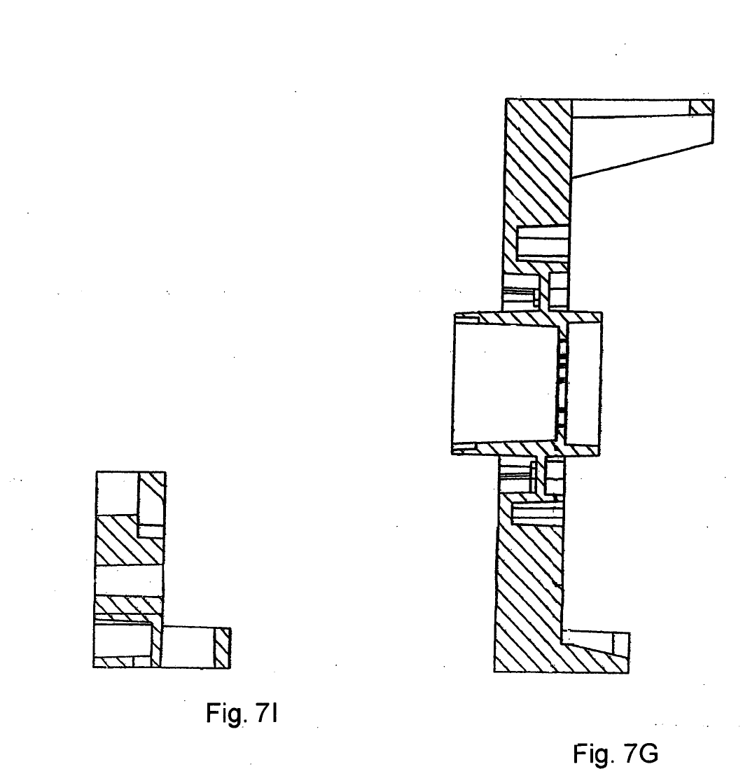

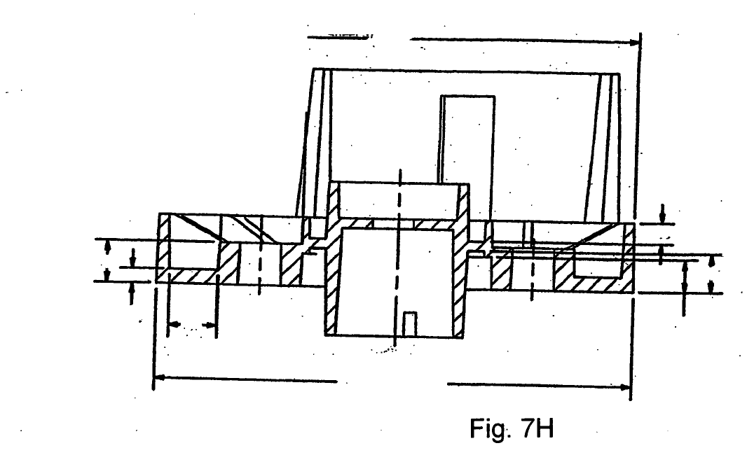

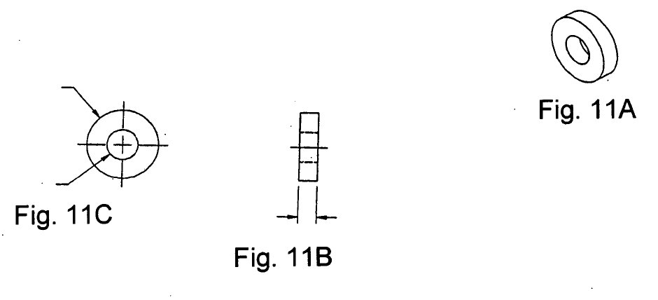

FIG. 11A and its sub-parts are various views of a knuckle connectable between the knuckle plate of FIG. 7A and the lamp cone of FIG. 6A.

FIG. 15A and its sub-parts are front and side views of a zero alignment gauge useable with the knuckle of FIG. 14A and the lamp cone of FIG. 6A.

FIG. 16A and sub-parts illustrate an alignment gauge usable with Fixture 10.

FIGS. 17A, 18A, and 19A, and their subparts, are various views, respectively, of an inside strap, outside strap, and inside stop strap useable with lamp cone of FIG. 6A to provide for accurate repositioning of the lamp cone if moved from factory alignment, for example, for maintenance purposes.

G. Miscellaneous Parts

FIG. 20A and its sub-parts are various views of a reflector gasket to seal the reflector frame at its connection to the lamp cone.

### IV. DETAILED DESCRIPTION OF EXEMPLARY EMBODIMENTS

A. Overview

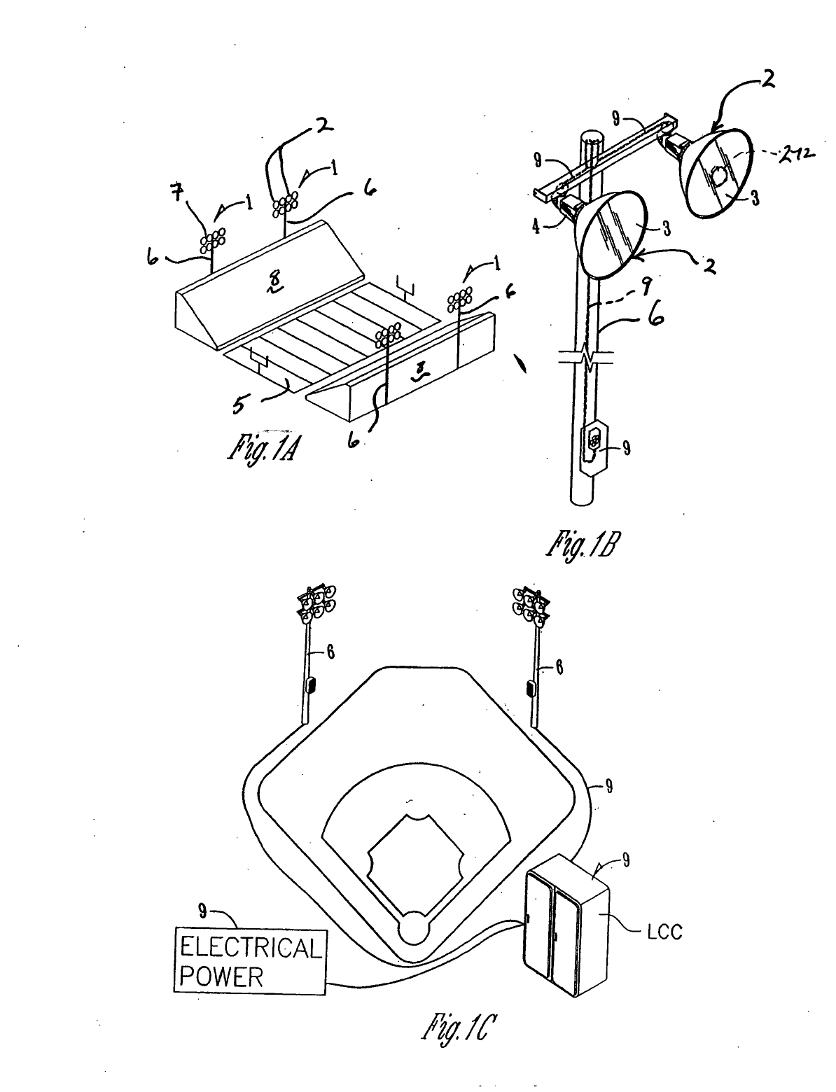

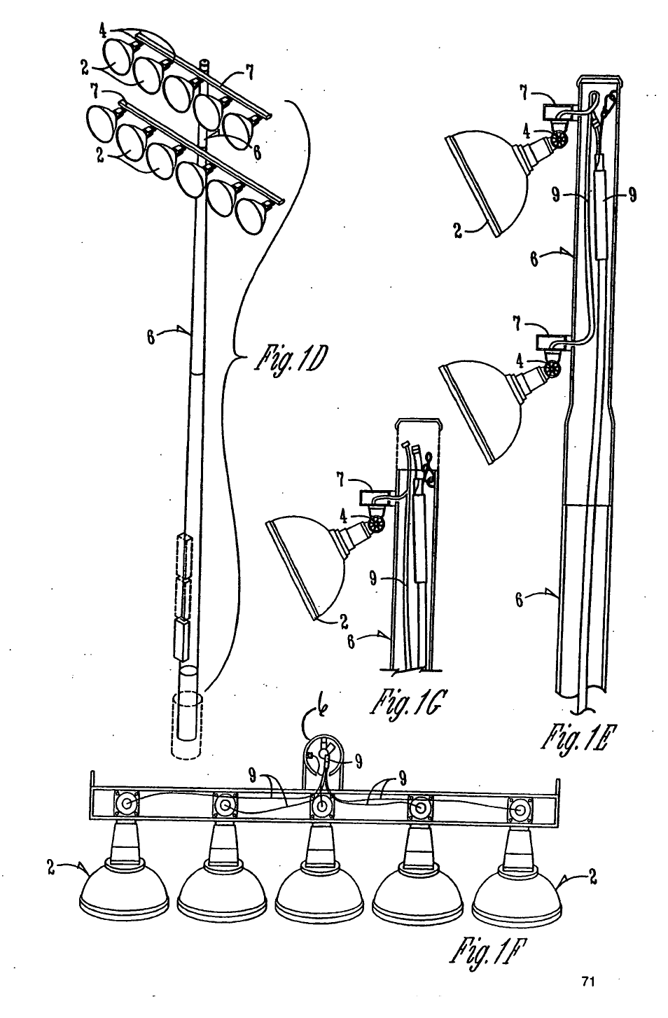

An embodiment of a light fixture will be described in the context of sports lighting, sports lighting fixtures, and sports lighting systems for the illumination of athletic fields such as shown in FIGS. 1A and 1C. The lighting must light the field and a volume of space above the field (collectively sometimes called the target area or target space), according to predetermined lighting level and uniformity specifications. The embodiment relates to fixtures that utilize high intensity discharge (HID) lamps, presently normally 1,000 watts or higher, of the metal halide type. Such installations generally have several arrays of fixtures usually elevated on two or more relatively tall poles (35 feet to 100 or more feet).

B. Exemplary Apparatus

1. Lighting Fixture 10 Generally

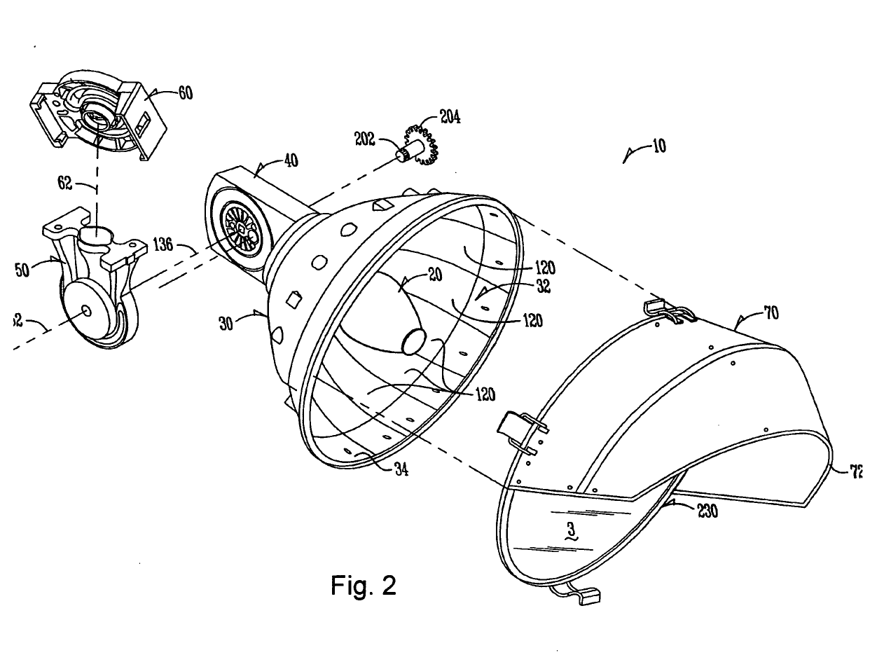

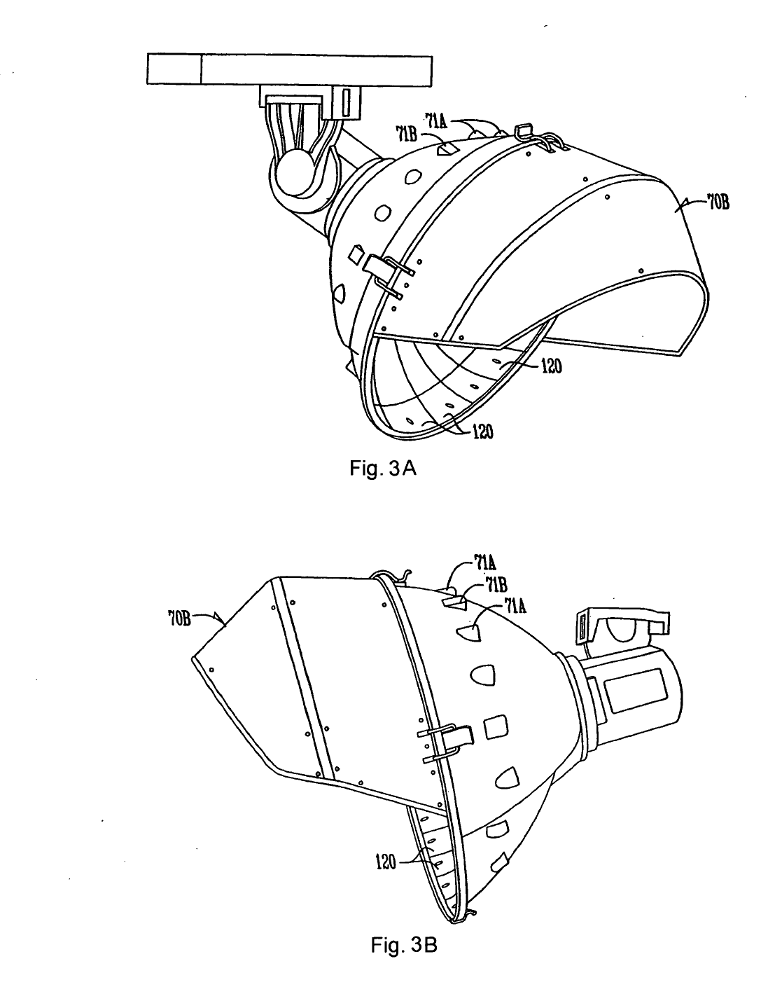

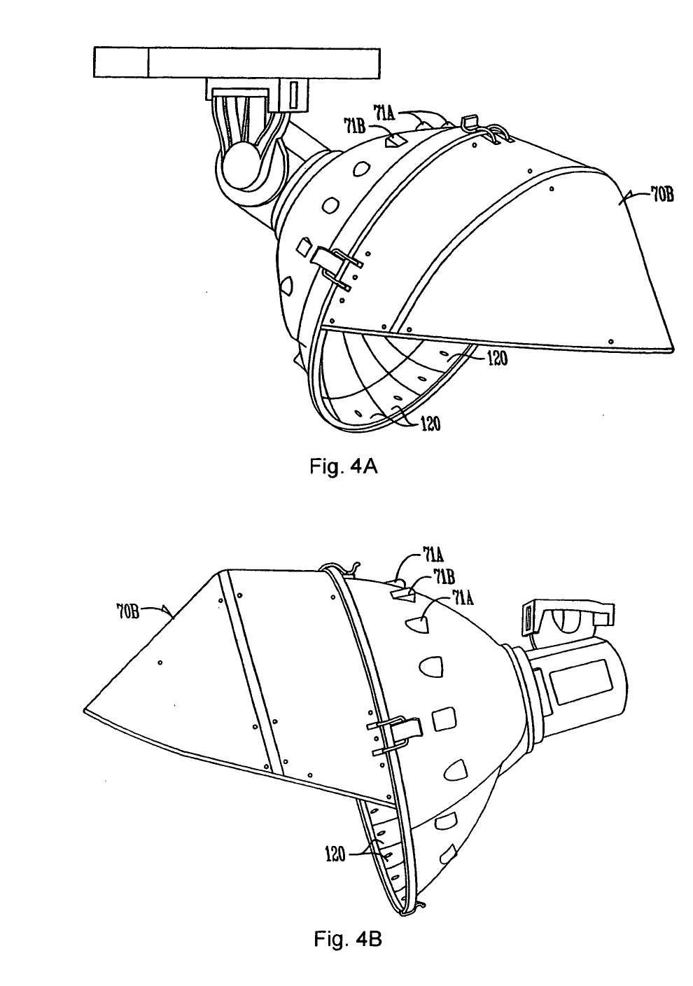

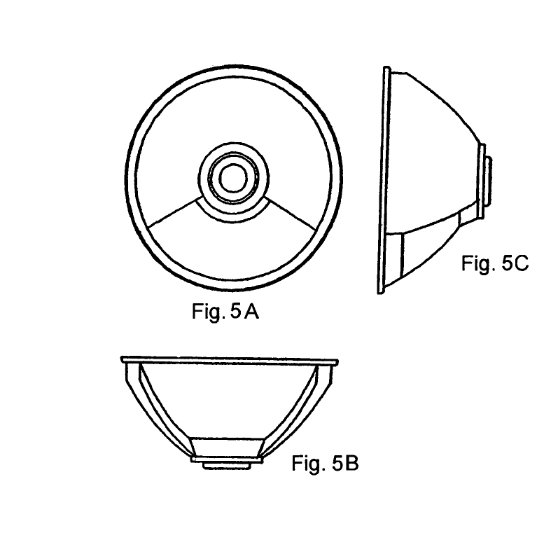

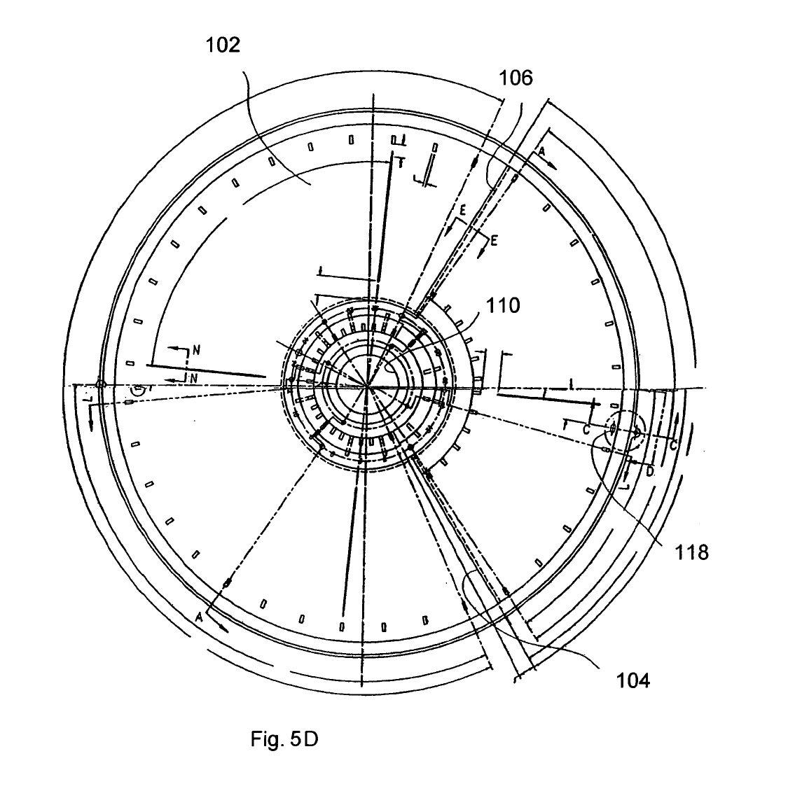

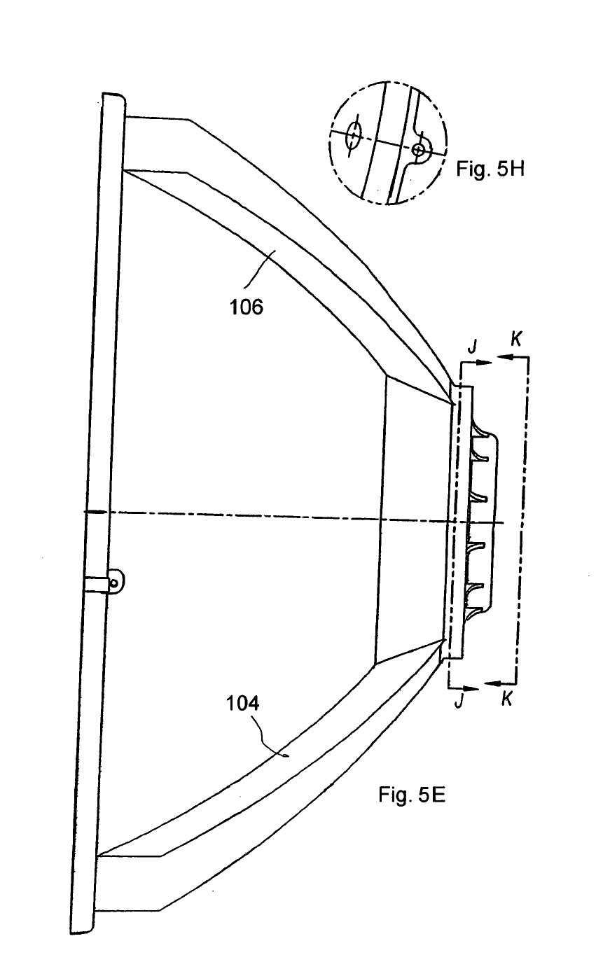

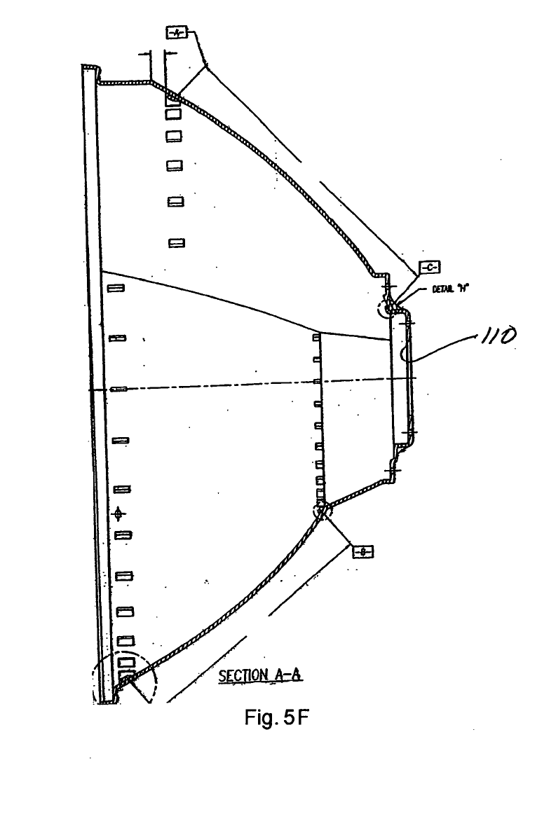

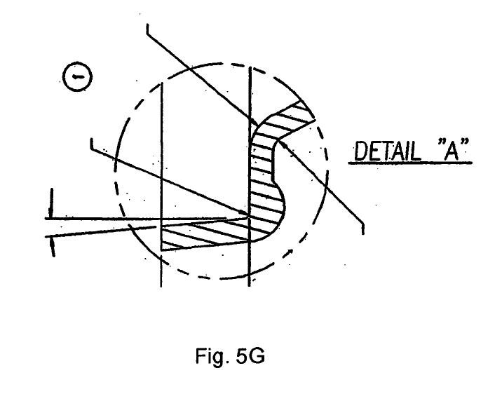

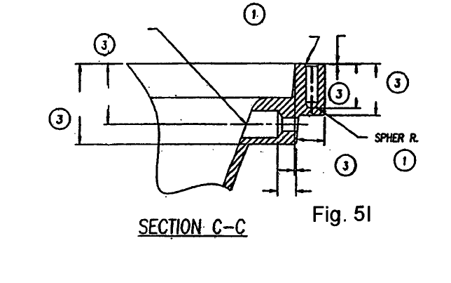

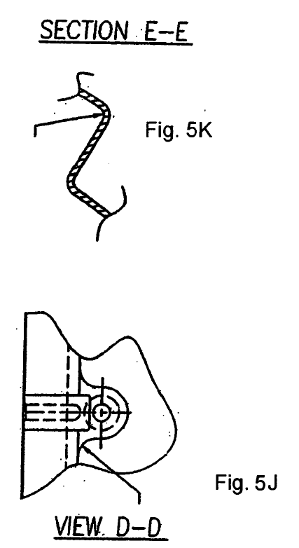

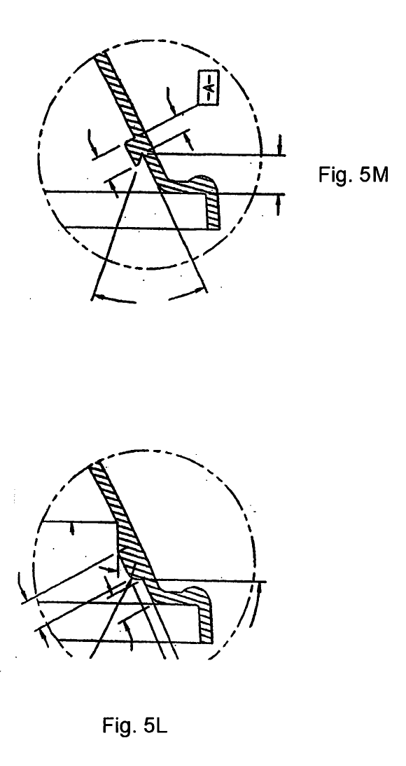

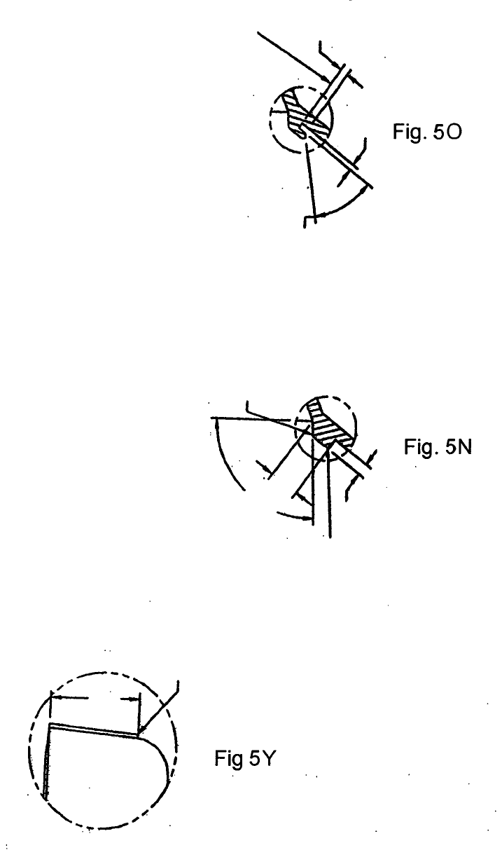

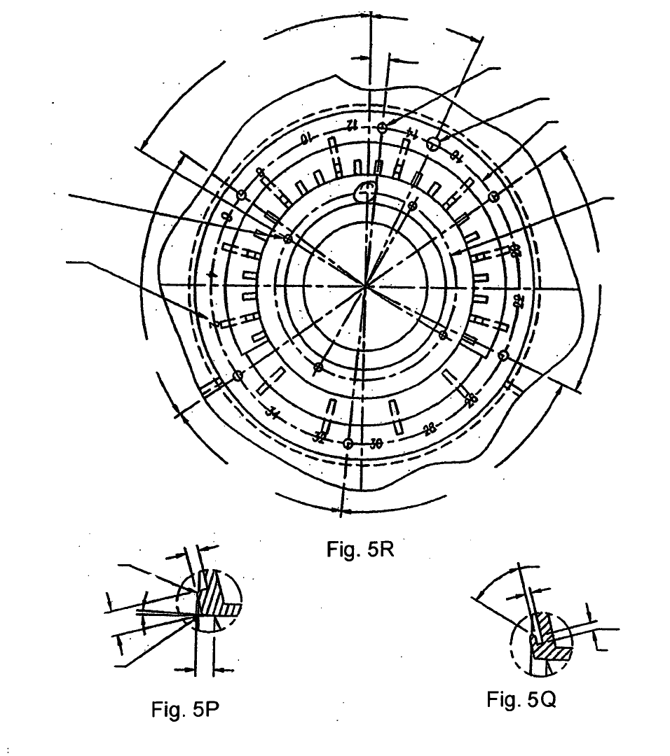

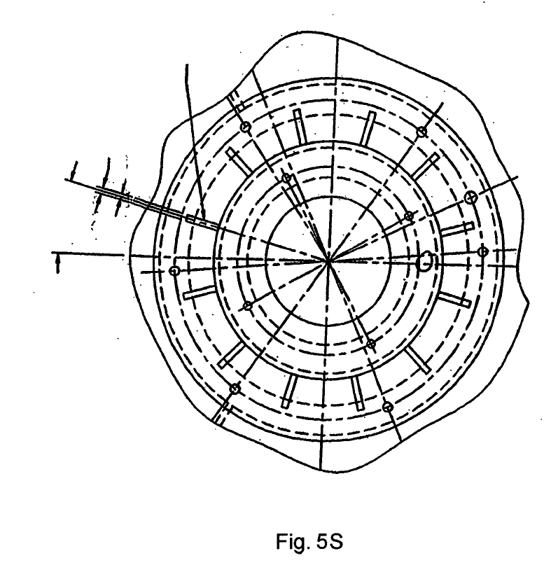

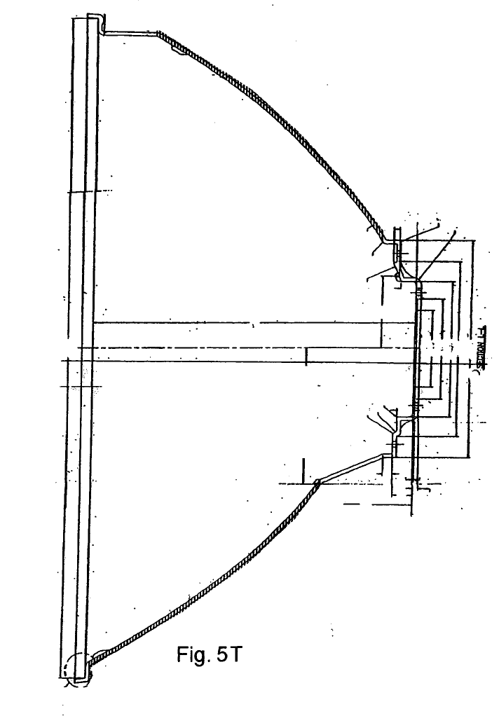

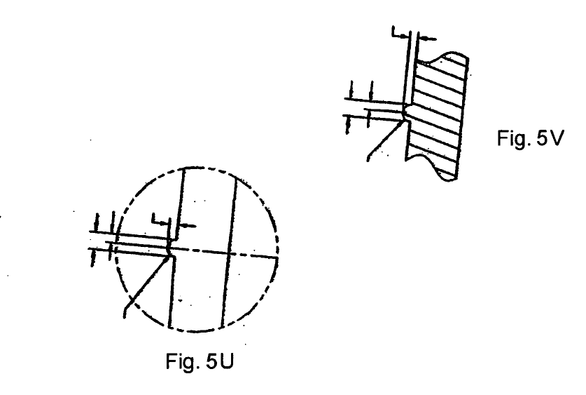

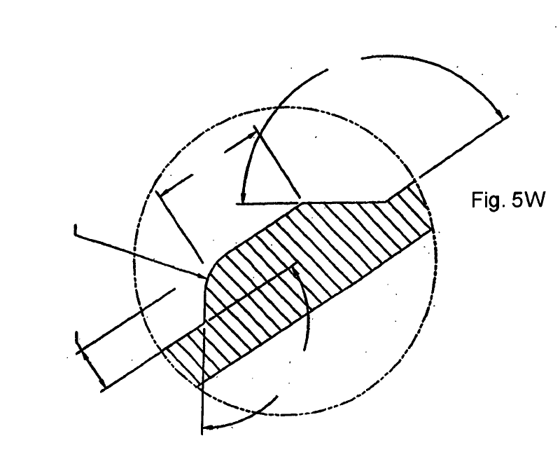

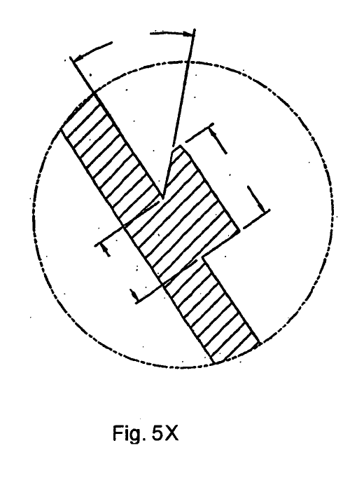

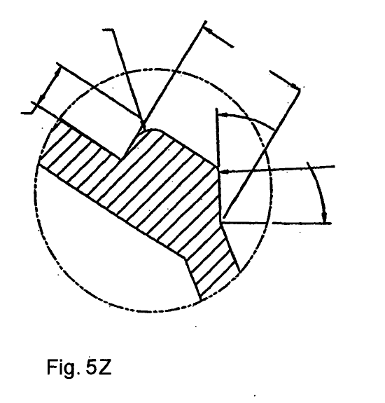

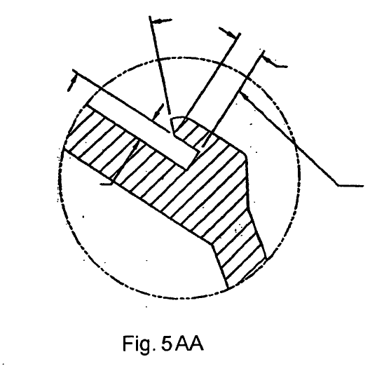

FIG. 2 shows the basic components of sports lighting fixture 10 in exploded form. FIGS. 3A and B show it in perspective form. FIGS. 4A and B show an alternative form. Fixture 10 has some similar general components to state-of-the-art sports lighting fixtures, but introduces some different structural components and concepts. Mounting or knuckle plate 60 (360 Aluminum with polyester powder coat) bolts to the underside of a cross arm 7. It has adjustability around vertical axis 62 (see FIG. 7A). Knuckle 50 (360 Aluminum with polyester powder coat) bolts at one end to the bottom of knuckle plate 60 and extends to a pivot connection to lamp cone 40 along axis 52 at its other end (See FIG. 4). It should be appreciated that knuckle 50 essentially supports the remainder of fixture 10 and does so with essentially one arm extending from a cross arm down to one side of lamp cone 40. Knuckle 50 is a relatively non-complex structure.

Lamp cone 40 (360 Aluminum with polyester powder coat) pivots around axis 52 relative to knuckle 50. It contains a socket 154 (see FIG. 19A, commercially available) which is bolted to the flat web 160 between the arms 156 and 158 of yoke 80 (see FIG. 19A). Lamp 20 (Musco Corporation Z-Lamp™) has a threaded base that can be screwed in and out of socket 154 (shown screwed into operating position in FIG. 2) to install or remove lamp 20.

2. Lamp Cone 40, Knuckle 50, and Knuckle Plate 60

Lamp cone 40, knuckle 50, and knuckle plate 60 form the adjustable joint between cross arm 7 and reflector frame 32. Lamp cone 40 also supports lamp 20. FIG. 6A and subparts illustrate details about lamp cone 40. Lamp cone 40 is basically enclosed except for front opening 132 to which reflector frame 30 is bolted and sealed with a gasket, and several opening in the side (e.g., for the knuckle bolt and a pinion gear).

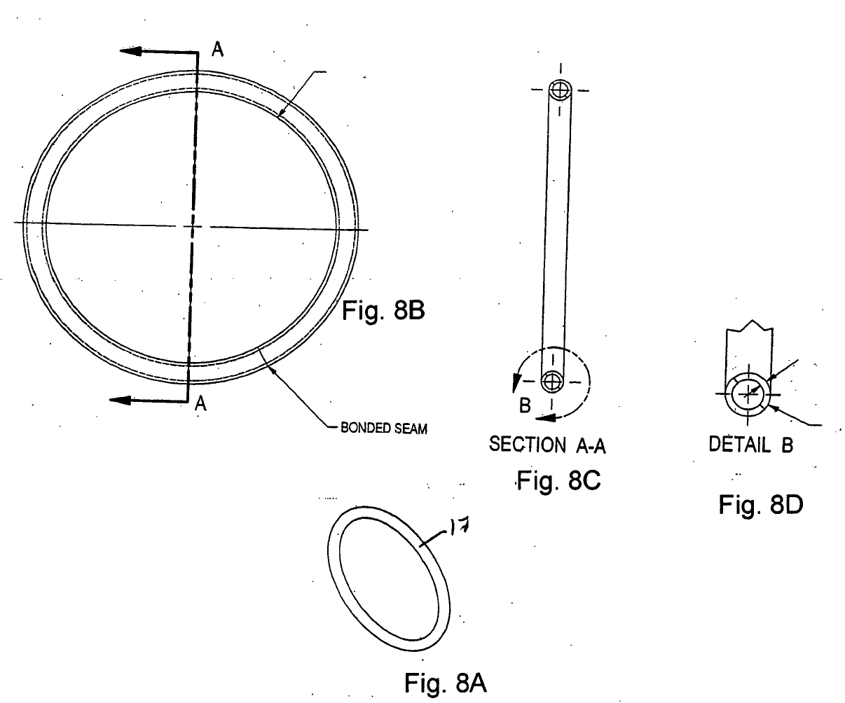

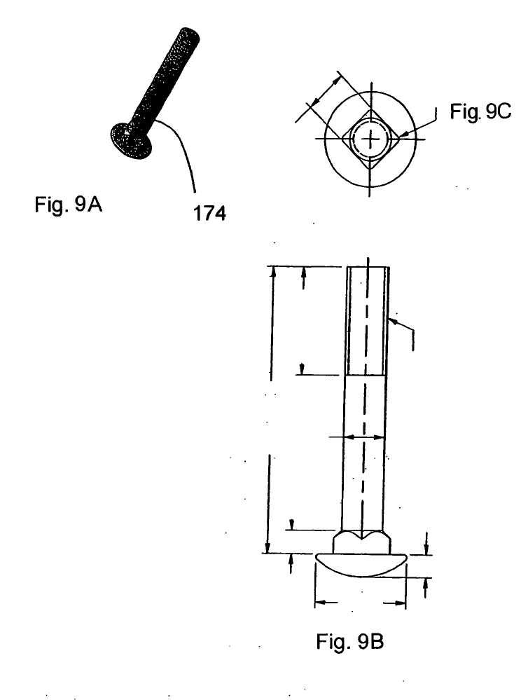

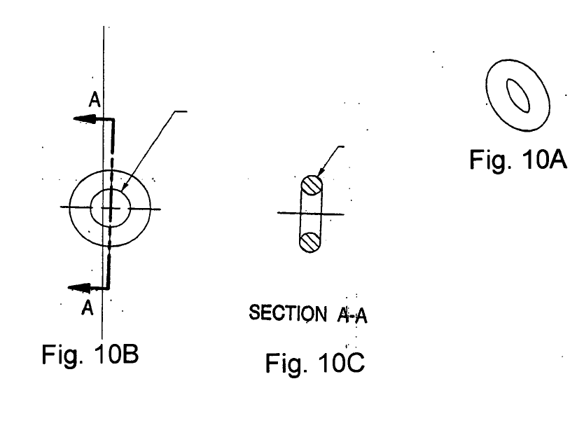

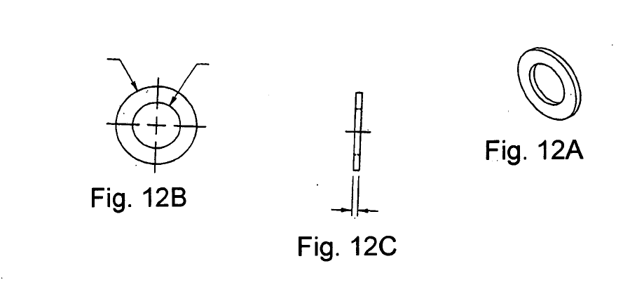

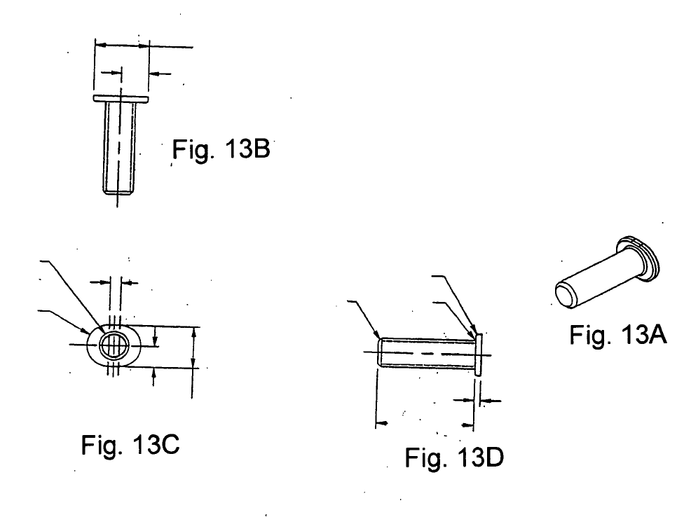

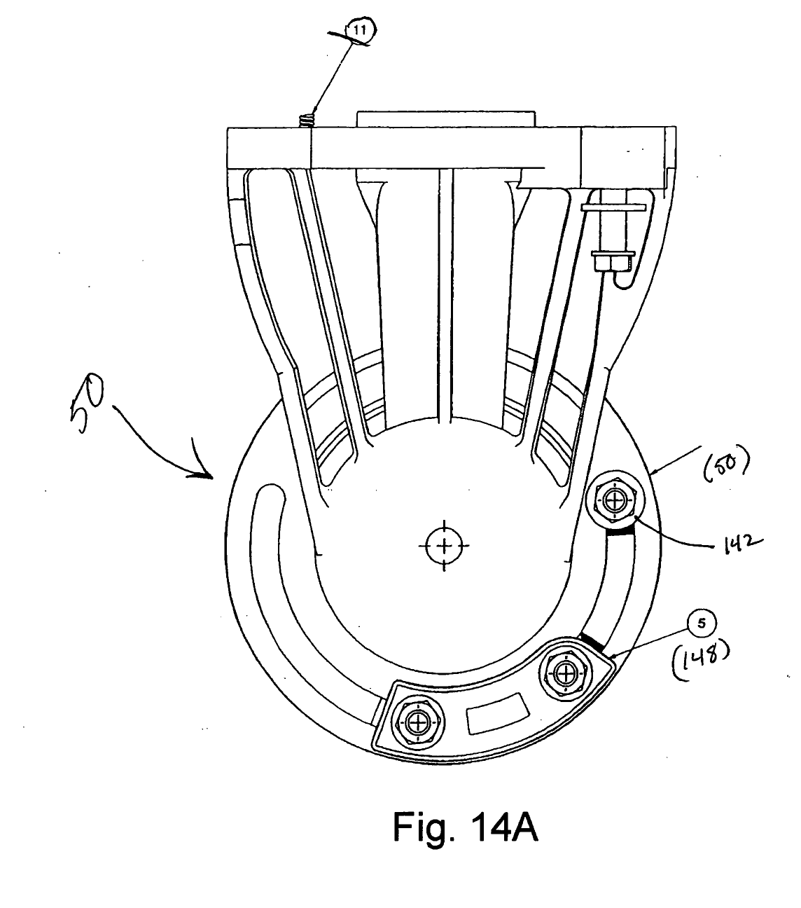

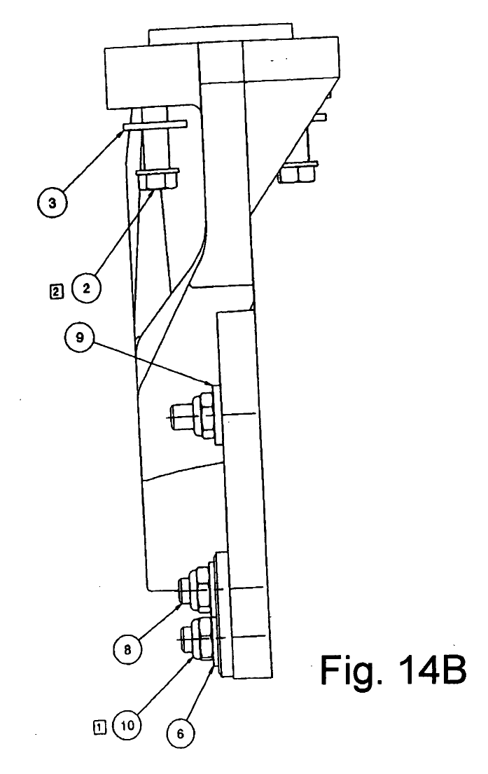

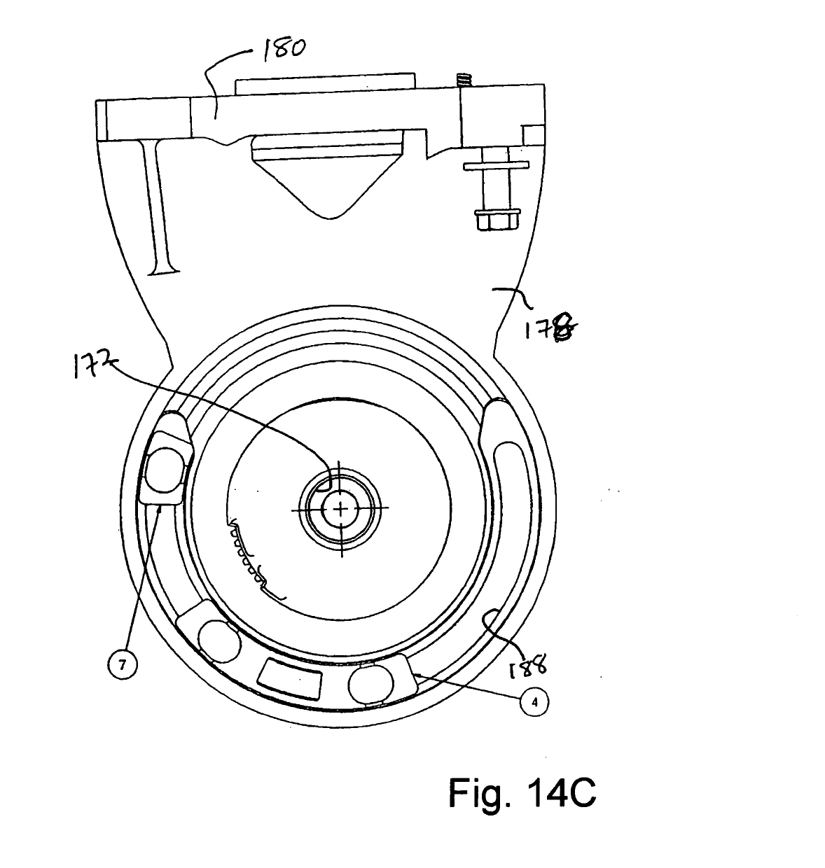

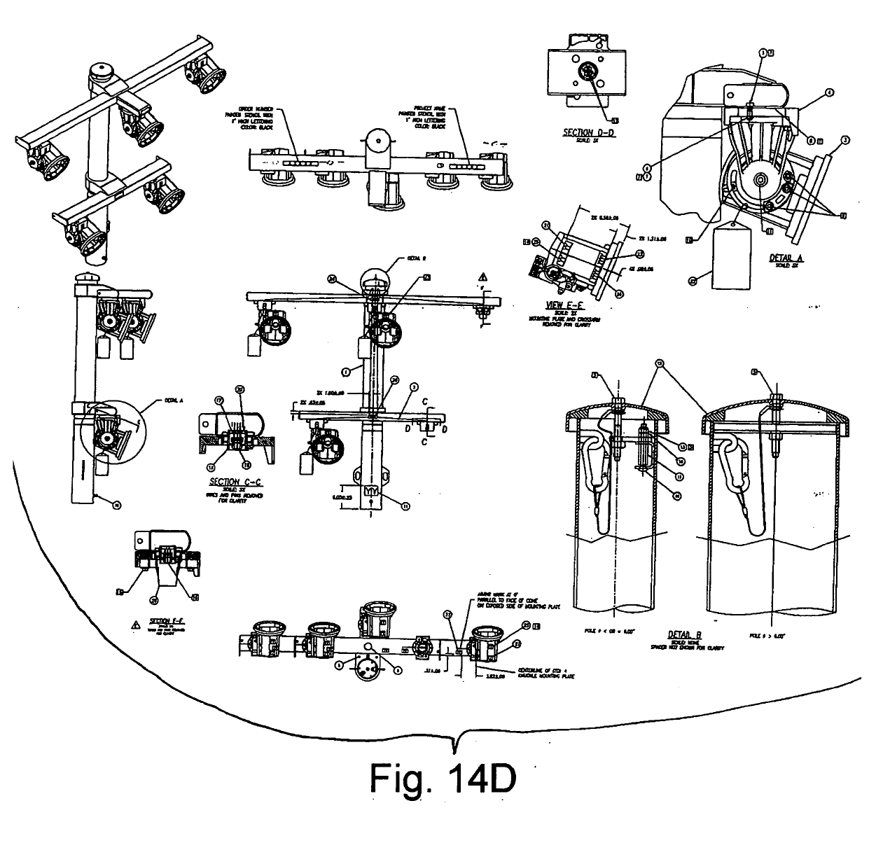

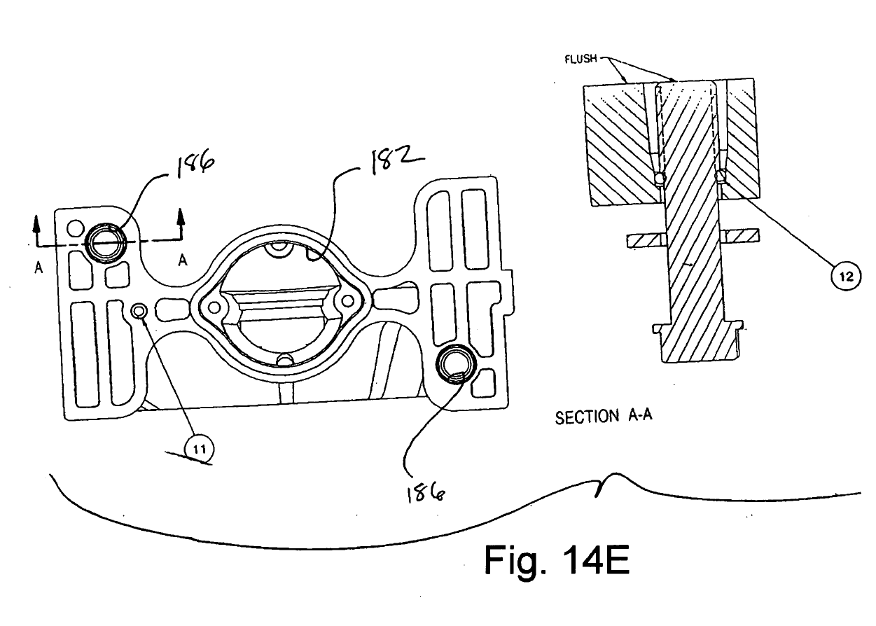

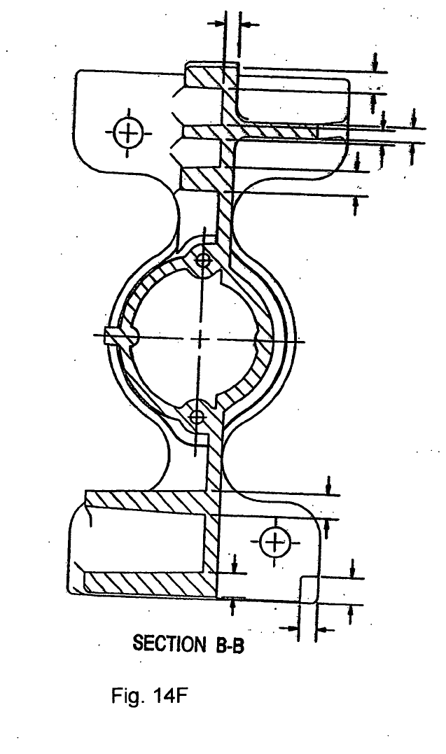

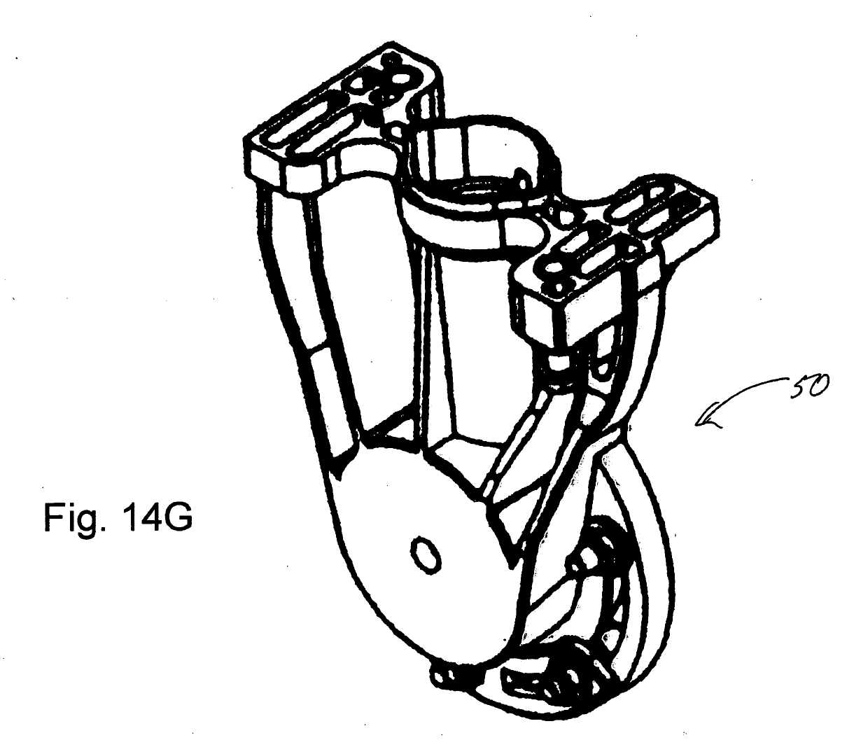

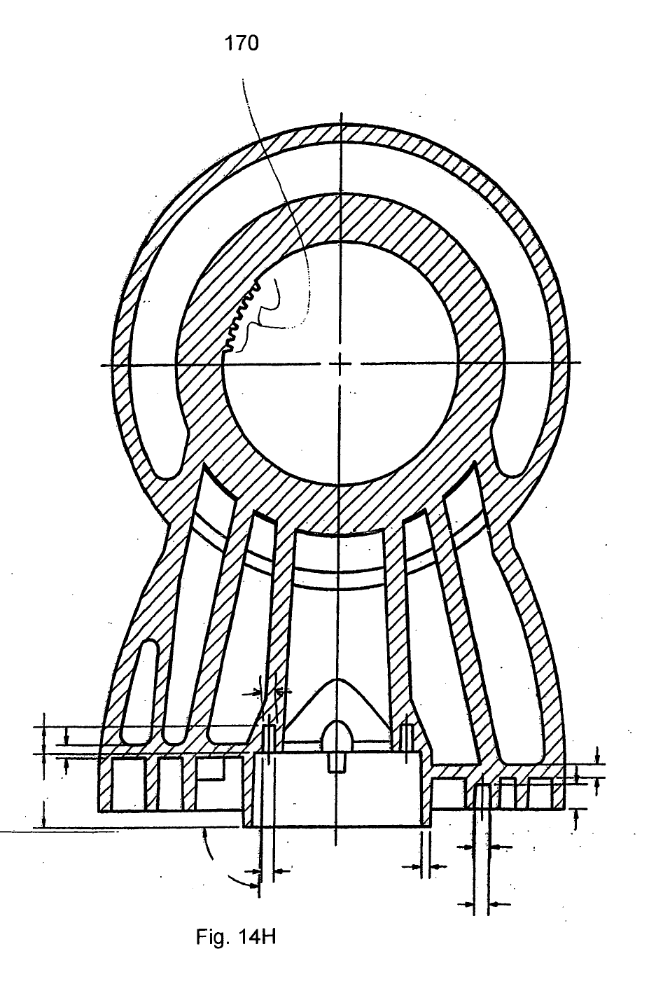

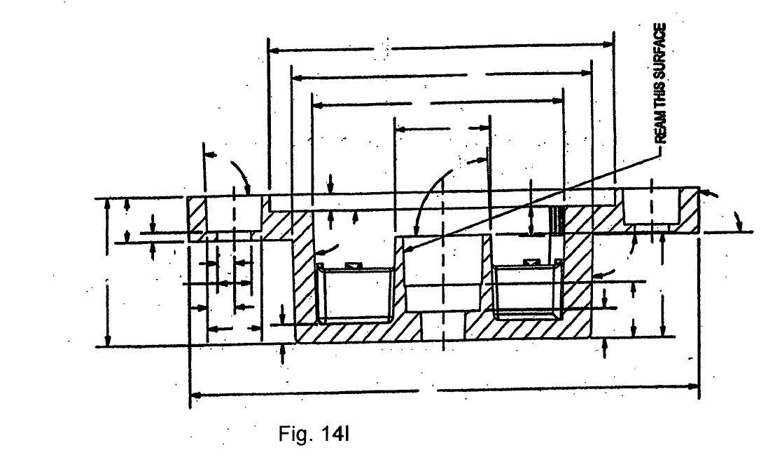

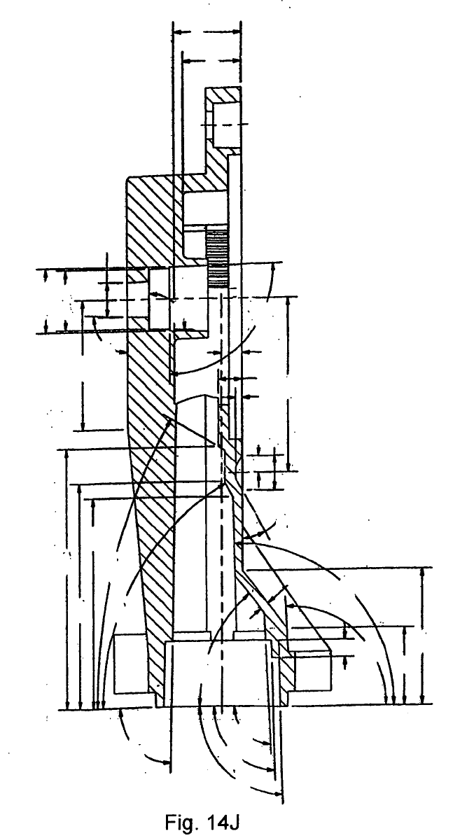

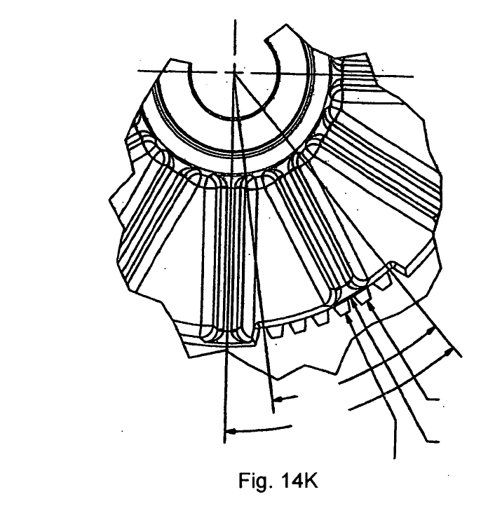

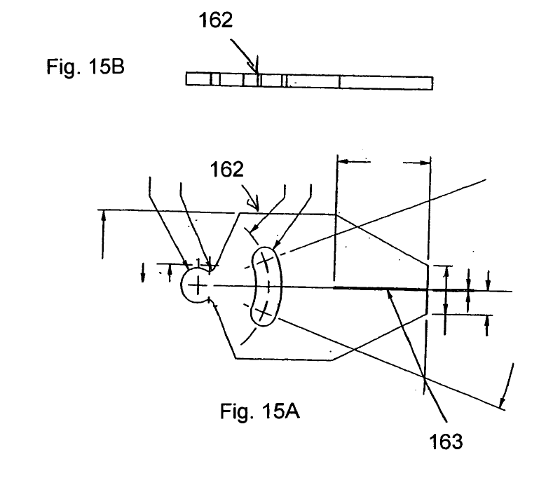

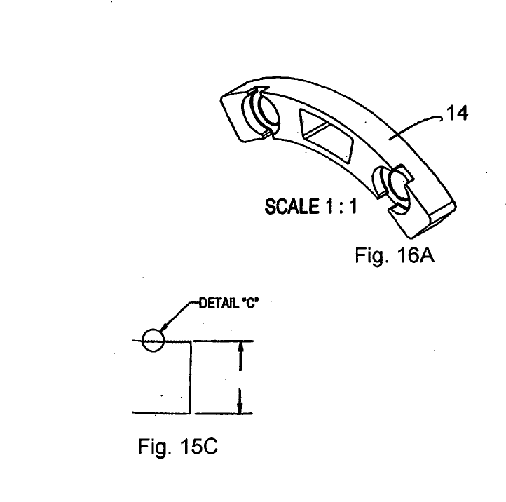

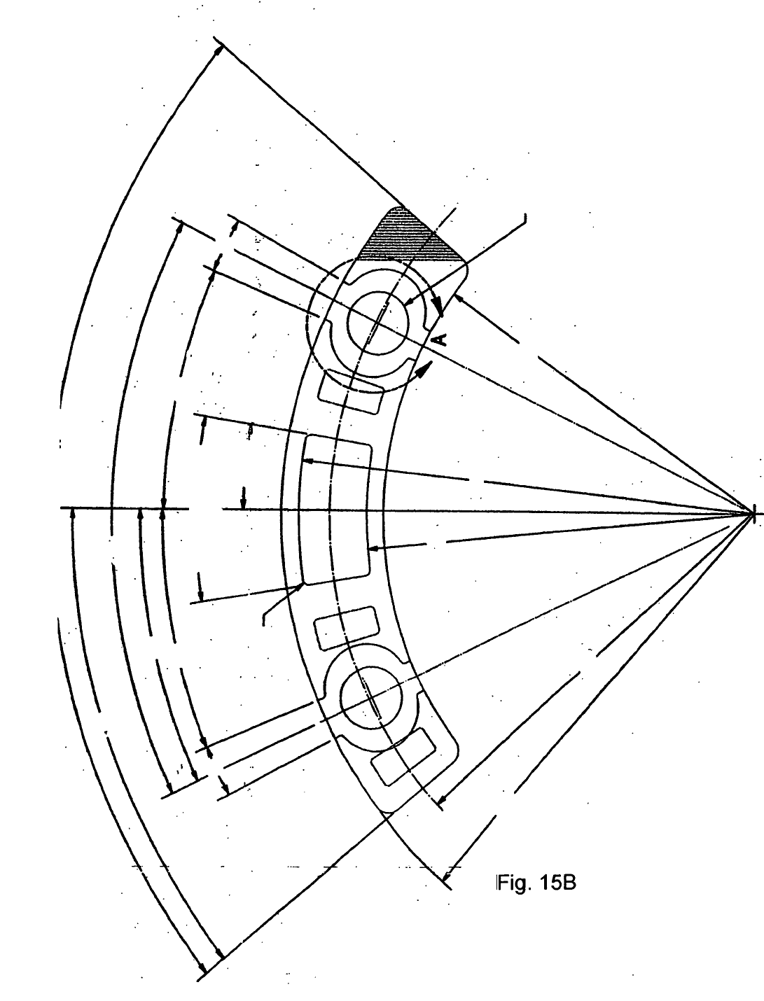

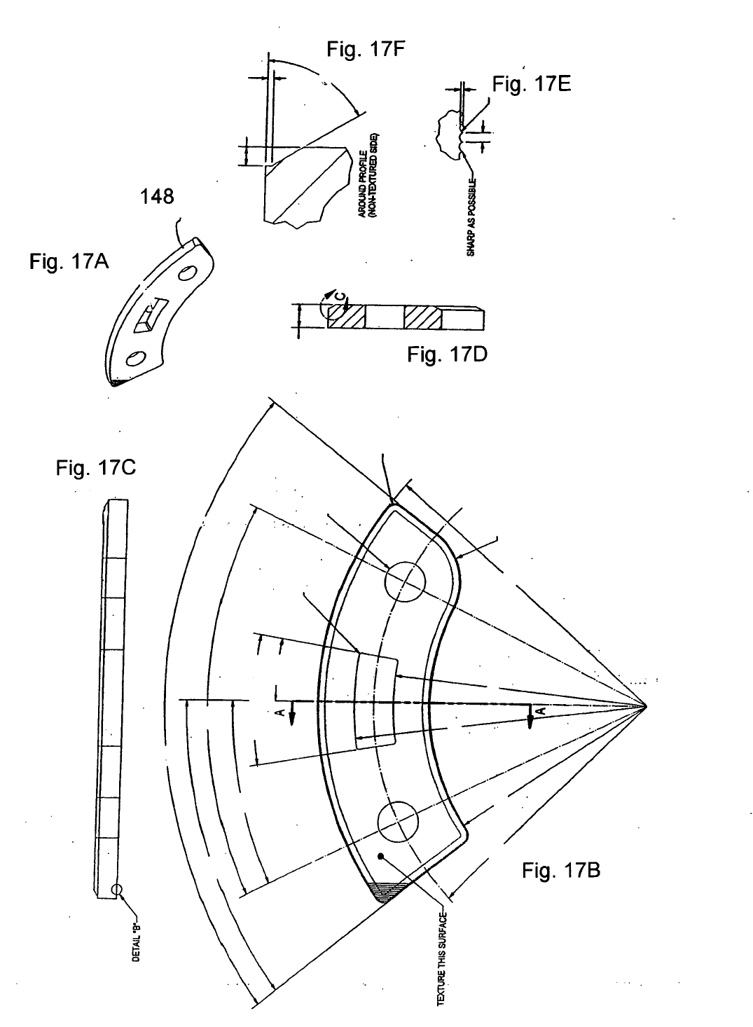

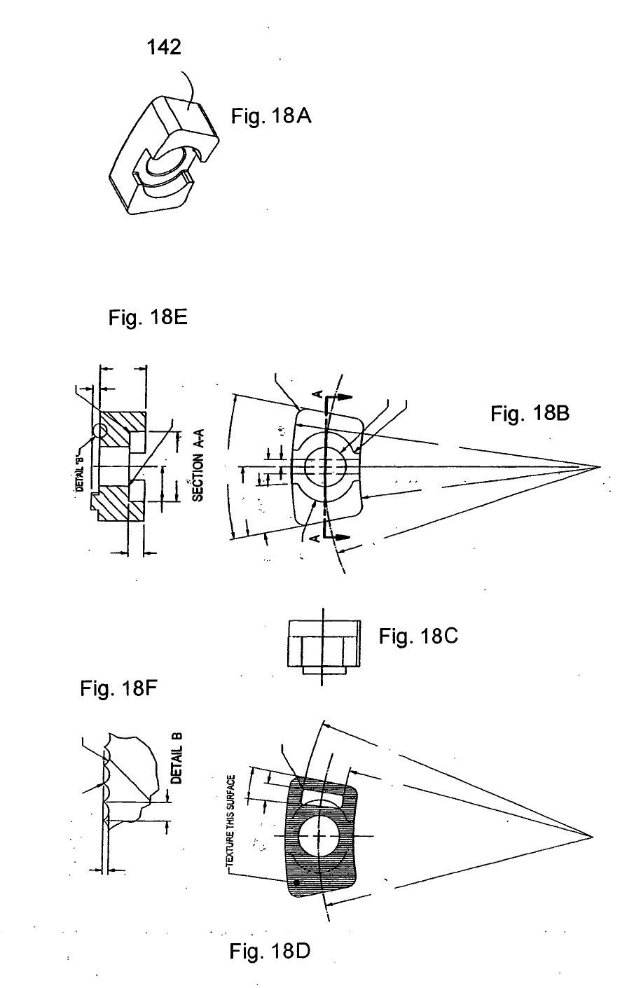

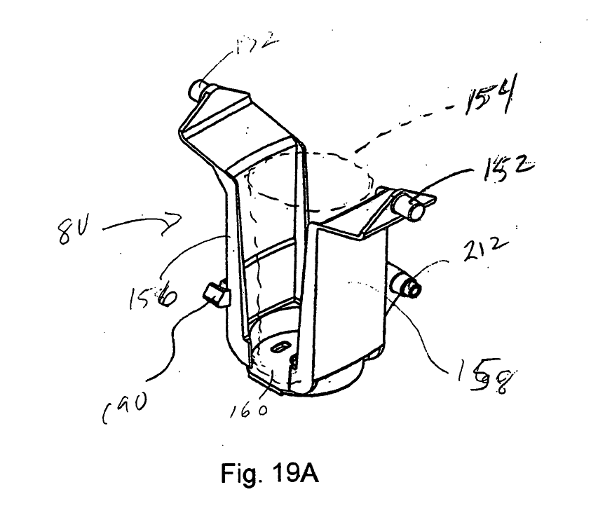

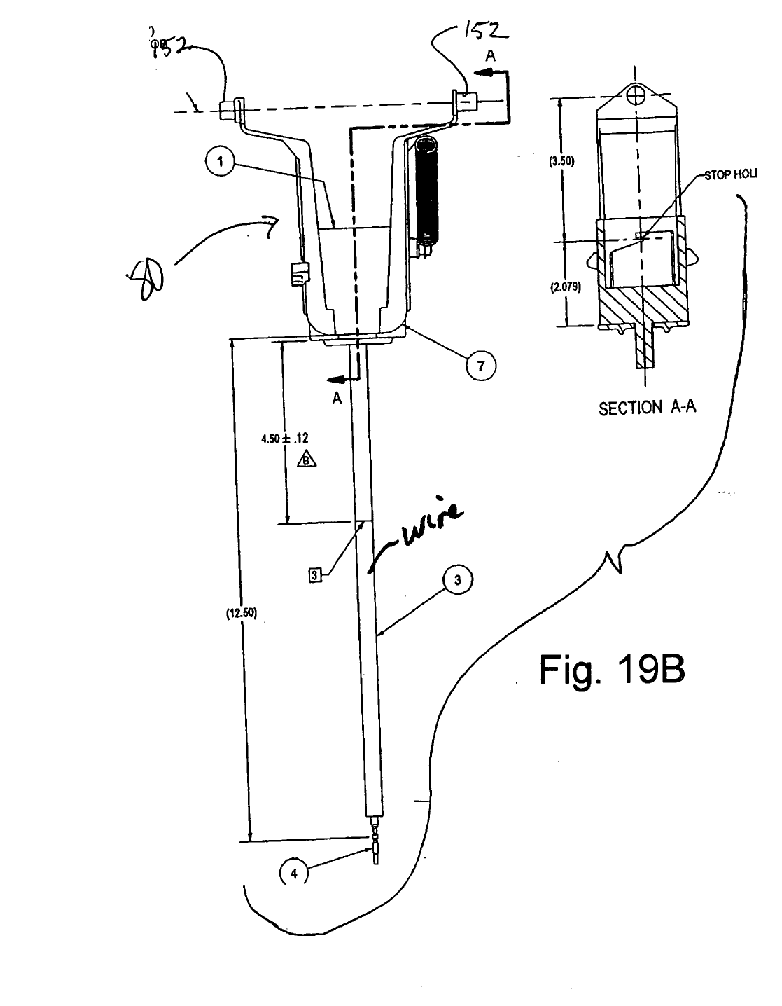

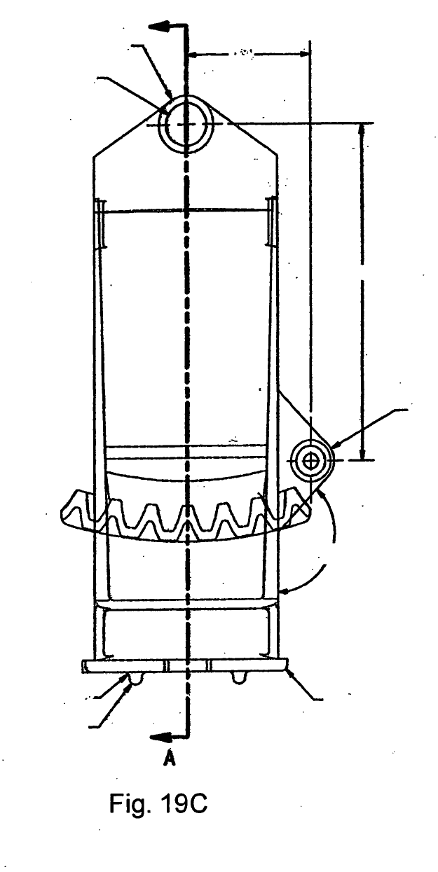

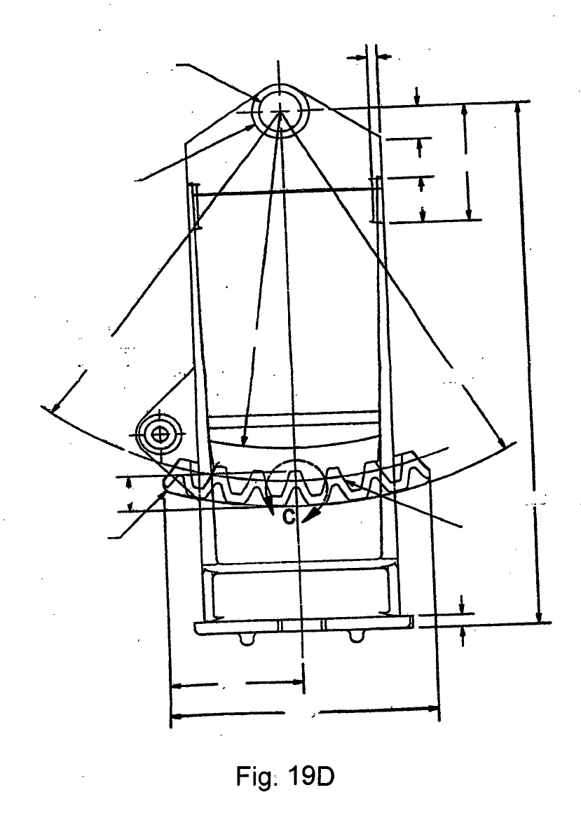

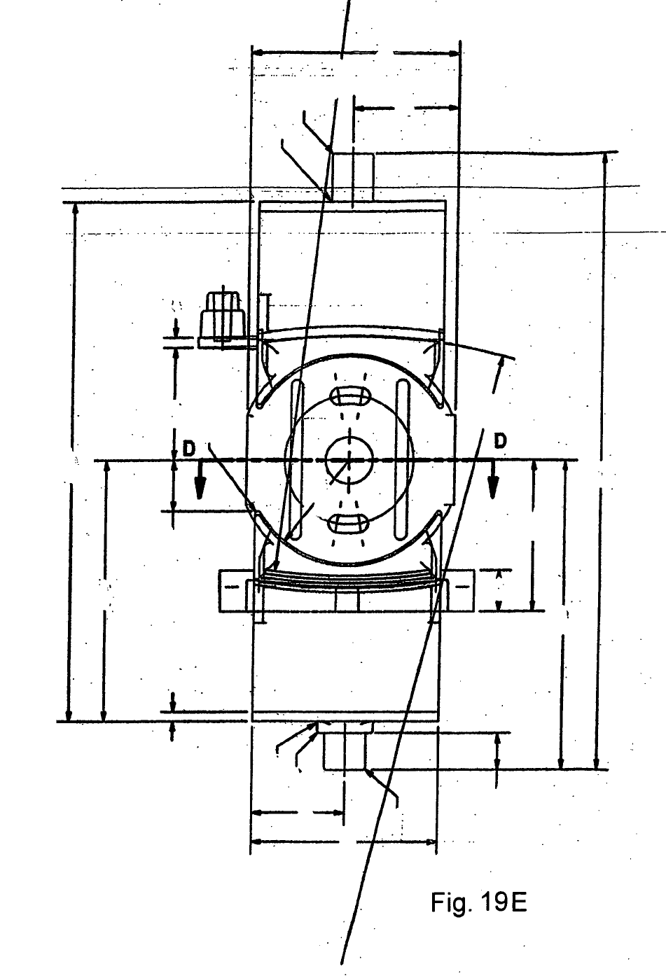

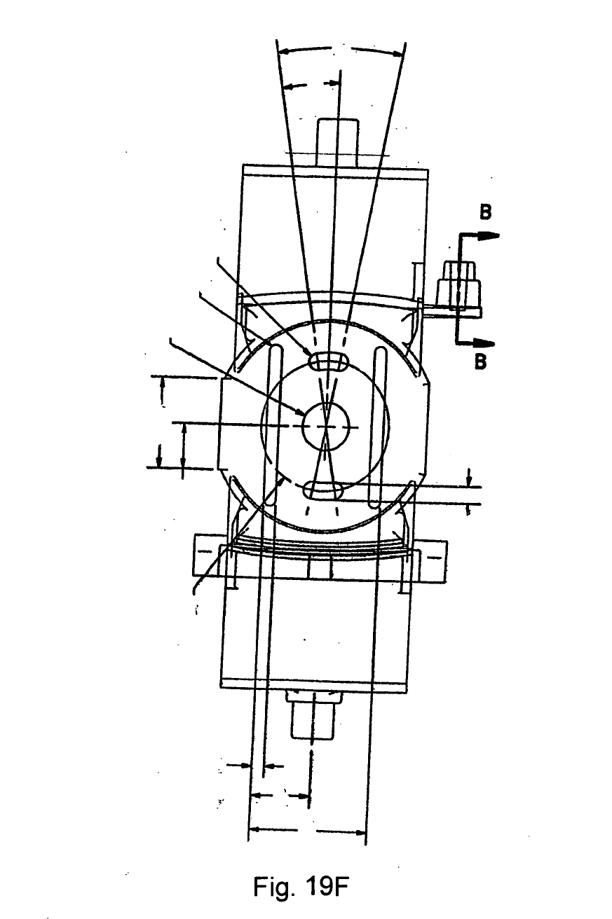

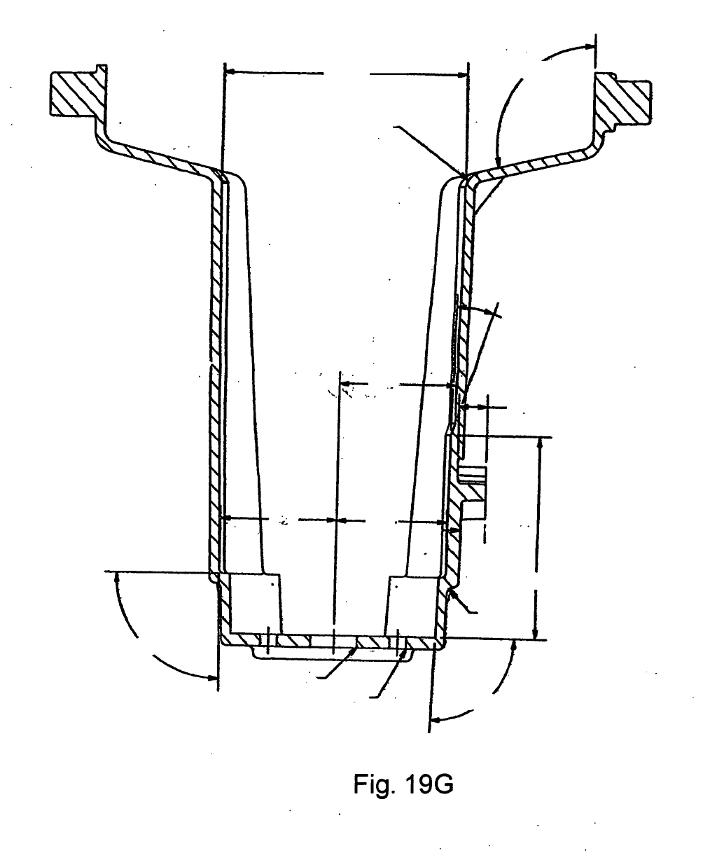

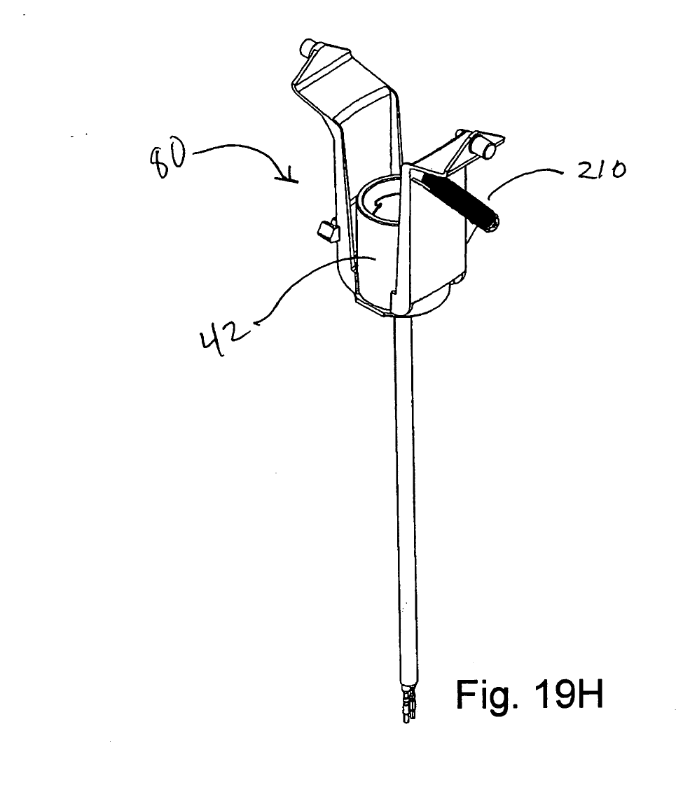

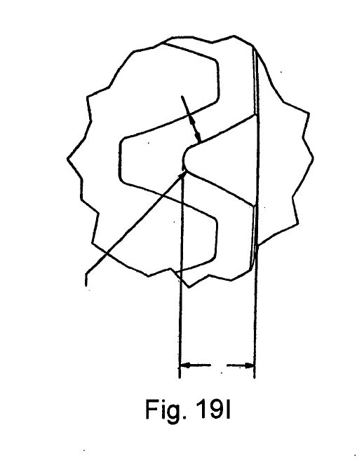

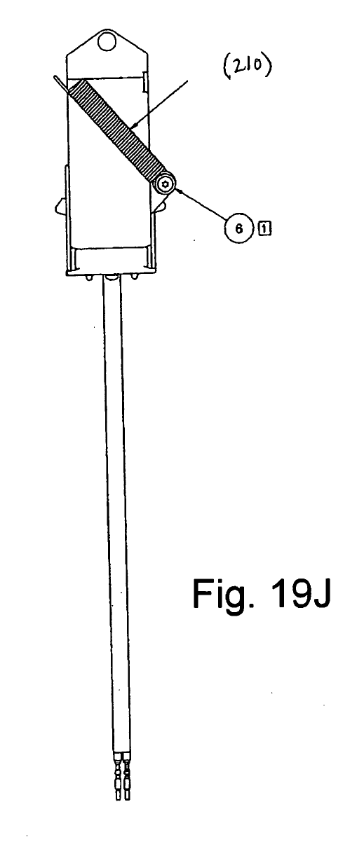

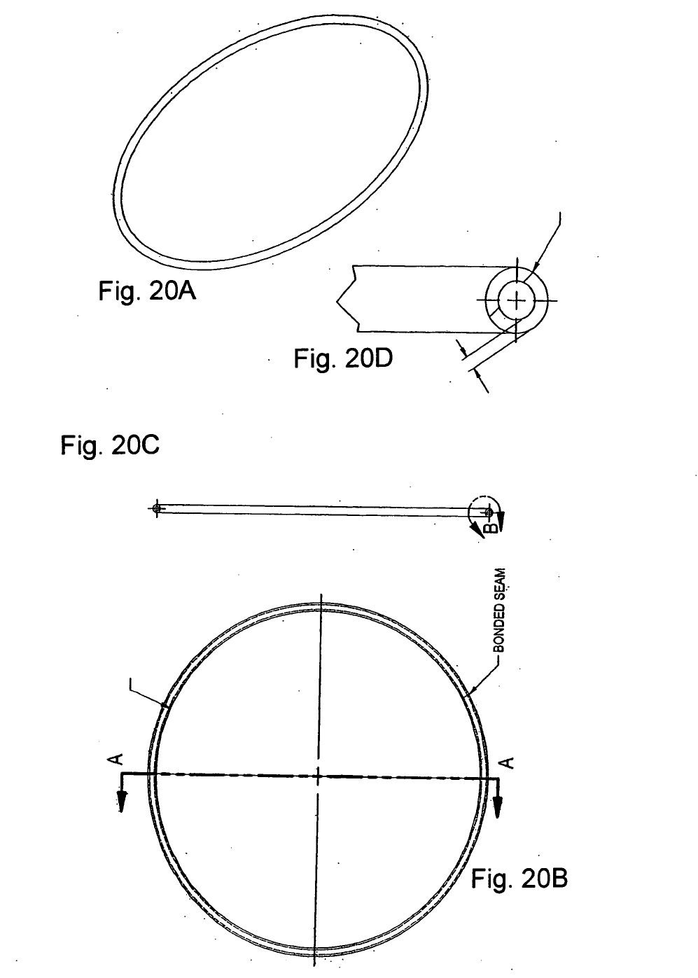

Lamp cone 40 pivotally attaches to knuckle 50 by inserting laterally projecting boss or pivot 136 on the side of lamp cone 40 into a complimentary circular cut-out or receiver 172 in one lateral side of knuckle 50 (see FIG. 14C). Knuckle bolt 174 (see FIGS. 9A, 10-12), with appropriate nut and washers, holds lamp cone 40 from separation from knuckle 50 when assembled together. Gasket 176 (FIGS. 8A-D) fits between lamp cone 40 and knuckle 50 concentrically about pivot receiver 172 and opening 174 and knuckle 50 to deter water, insects, or dirt from entering into knuckle 50. As can be seen in FIGS. 6 and 14, when these parts are assembled, complimentary structure on the interfaces of lamp cone 40 and knuckle 50 act as bearing surfaces and retaining structure to provide for smooth, accurate rotation of lamp cone 40 relative to knuckle 50.

As shown in the drawings, knuckle 50 connects to knuckle plate 60 (see FIG. 7A) which in turn is fixedly mounted to cross arm 7. Arm portion 178 of knuckle 50 extends to a mounting end 180. Knuckle plate 60 bolts to the bottom of cross arm 7 by one bolt into each curved slot 194 and 196. This allows rotational adjustment of knuckle plate 60 relative to cross arm 7 over the range of curved slots 194 and 196.

It should be noted that knuckle 50 is essentially a single arm suspending most of fixture 10 by its pivotal connection along the side of lamp cone 40. Unlike some existing fixtures which have the knuckle extend directly into the back of the lamp cone, and a pivot joint between the cross arm and the lamp cone, knuckle 50 provides certain functional advantages. First, although fixture 10 might be somewhat heavier than a spun aluminum reflector fixture, by placing the pivot point along the side of lamp cone 40, there is less moment caused by lamp cone 40, reflector frame 30, lamp 20, visor 70 and the other components on the distal side of that connection point. It is believed the moment is cut approximately in half. This is beneficial for long-term durability, especially for fixtures experiencing a variety of outdoors forces and conditions, including high winds. Less moment for the connection also deters slippage or change in relationship between the lamp cone and cross arm, which could affect aiming. Secondly, it allows for a shorter fixture, in the sense the fixture is pulled closer to the vertical plane of the cross arm. This helps present a lower EPA. Third, knuckle 50 provides for minimum exposure of power wires to the environment. The wires pass through knuckle plate 60 (from the interior of cross arm 7), through the interior of knuckle 50, and into the interior of lamp cone 40, completely enclosed by structure. Fourth, it is part of a relatively non-complex structure for the support and aiming of the fixture.

Round opening 182 at the mounting end of 180 of knuckle 50 fits around downwardly extending tube 192 on the bottom of knuckle plate 60. Bolts through bolt holes 184 and 186 of mounting end 180 of knuckle 50 extend into curved slots 194 and 196 in knuckle plate 60. This combination allows a range of rotational adjustment of knuckle 50 relative to knuckle plate 60 (over the range defined by curved slots 194 and 196 of knuckle plate 60). In this manner, there is some adjustability of knuckle 50 around a vertical axis, once knuckle plate 60 is mounted to the underside of cross arm 7.

Curved slot 188 in knuckle 50 provides a limit for pivoting of lamp cone 40 about knuckle 50. Knuckle 50 can therefore be used for aiming fixtures 10 to either side of cross arm 7. Additionally, lamp cone 40 can be set to a given aiming angle relative knuckle 50 as follows. An inside stop strap 142 can be fixed to boss 144 in the face of lamp cone 40. Inner and outer stop straps 146 and 148 can be bolted on opposite sides of curved slot 188 of knuckle 50 in a position so that when lamp cone 40 is rotationally adjusted relative to knuckle 50 for its intended aiming angle, inner and outer straps 146 and 148 would come into abutment with stop strap 142. Thus, the installer of the light system can have a factory-preset stop at the correct aiming angle for each fixture 10. This avoids individual aiming of each fixture when the system is installed at the field. Additionally, it allows easier maintenance. Bolt 174 holding lamp cone 40 to knuckle 50 can be loosened, lamp cone 40 and reflector frame 30 etc. can be swung down. Maintenance can be performed. Without realigning or re-aiming, the worker then only has to swing that reflector frame 30 etc. back up until it hits stop strap 142 and retighten lamp cone 40 to knuckle 50. Knuckle 50 can be die cast and removable mounted to die cast reflector frame 30 with gaskets or other structure to prevent leaks at that interface of parts.

C. Assembly and Use

In practice, a set of fixtures 10, such as described above, would be used in a sports lighting system customized for a particular sports field. Lighting specifications (usually including light quantity and uniformity minimums; and sometimes glare, spill, and halo light limitations) are usually prepared or known. As is well known in the art, computer software can design the lighting system, including what types of beams and beam shapes from how many fixtures at what locations are needed to meet the specifications. It can generate a report indicating number of fixtures, pole locations, beam types, and aiming angles to meet the design.

As described above, fixtures 10 can be assembled to produce a wide variety of beams and commonly used beam shapes for sports lighting. Using the report, a set of fixtures 10 can be pre-assembled at the factory. The appropriate reflector frame 30 for each beam type called for in the report can be pulled from inventory by the assembly worker. About one-half the reflector frames will include a side shift section 109 (and about one-half of those split between left shift and right shift). Likewise, the appropriate reflector inserts 120, visor 70A or B, and visor reflective inserts 72 will be pulled from inventory for each fixture according to its position and function in the report.

The assembly worker(s) will mount the appropriate reflective inserts 120 on the pins on each reflector frame 30, and the appropriate visor reflective strips 72 on visor 70 for each fixture 10 (depending on the precise structure of visor 70, mounting straps or brackets may first be secured to visor 70). Glass lens 54, with anti-reflective coatings on both sides installed, is assembled into lens rim 230 with visor 70 attached.

A Z-lamp™ 20 of the appropriate wattage is screwed into socket 154 for each fixture 10 and aligned, through the pin and slot method and/or by correction slots, so that the plane defined by the longitudinal axis of arc tube 12 and the longitudinal axis of lamp 20 is in appropriate alignment relative to reflector frame 30.

Other parts, including those specifically described above, are assembled, to complete each fixture 10 for the given lighting system, including latching the lens 54/visor 70 combination over reflector frame 30, and sealing all holes except for placement of filter in its designated opening. The assembly worker(s) take appropriate measures to avoid any foreign substances from adhering or being inside reflector frame 30 after lens 54/visor 70 is sealingly mounted to it. This includes peeling away the release sheet protective covers on the high reflectivity inserts for reflector frame 30 and visor 70.

Fixtures 10, a pole top with pre-assembled cross arms 7, and poles are shipped to the field to be lighted, along with aiming diagrams, showing how each pre-designed fixture should be aimed relative the field. The entire system, namely poles and bases for the poles, cross arms, fixtures, wiring, ballast boxes, etc. can substantially pre-assembled at the factory (see Musco U.S. Pat. No. 5,600,537, incorporated by reference herein). This pre-assembled system is available from Musco Corporation under the Light Structure™ brand name.

At ground level, knuckle plates 60 are attached to cross arms 7 and the appropriate fixture 10 is attached to its appropriate knuckle plate 60 by its knuckle 50 (after wiring for that fixture is connected to pre-wiring in cross arm 7. The knuckle for each fixture 10 is adjusted to match the indicated aiming for that fixture 10 according to the aiming diagram (using the pole as a reference point, as described later). Once aimed, the inner and outer knuckle straps and knuckle stop strap, are bolted in place so that the correct aiming position for the fixture is set. Any pivoting of fixture 10 above or below the reference position for arc tube 12 will result in automatic tilt factor correction movement of yoke 80 for that lamp 20.

The poles are erected vertically. Electrical power from a control cabinet is connected to each ballast box on each pole.

It can therefore be seen that the invention achieves at least all of its stated objectives, aspects, advantages and options. It departs from the state-of-the-art in the ways described. It will be appreciated, however, that the invention can take various forms and embodiments. Variations obvious to those skilled in the art will be included within the invention, which is defined solely by its claims.

What is claimed is:

1. A high intensity lighting fixture for increasing useable light to a target area without an increase in energy use comprising:
a. a lamp cone;
b. a knuckle attachable to the lamp cone for use in adjustable mounting to a cross-arm or other suspending structure;
c. a reflector mountable to the lamp cone and comprising a bowl-shaped outer surface and an inner surface including a reflecting surface, and a primary opening over which a glass lens is mountable;
d. a high intensity discharge lamp having a base mountable into the lamp cone and an arc tube positionable in the interior of the reflector frame substantially surrounded by the reflecting surfaces;
e. the knuckle pivotably attachable to the lamp cone along its side.

2. The fixture of claim 1 wherein the knuckle is relatively thin compared to the lamp cone.

3. The fixture of claim 1 further comprising a sealing member between the knuckle and the lamp cone.

4. The fixture of claim 1 further comprising substantially internal pathways for wiring into the lamp cone for protection of the wiring.

5. The fixture of claim 1 wherein the pivotal attachment of the knuckle to the lamp cone along its side provides decreased moment.

6. A high intensity lighting fixture comprising:
a. a lamp cone;
b. a knuckle for use in adjustable mounting to a cross arm or other suspending structures;
c. the knuckle pivotally attachable to the lamp cone along its side.

7. A method for decreasing moment and effective projected area where a lighting comprises:
a. mounting a knuckle for attaching the light fixture cross arm along the side of a lamp cone of the fixture.
